(19) United States
(12) Patent Application Publication
(10) Pub. No.: US 2016/0379301 A1
(43) Pub. Date: Dec. 29, 2016

(54) SYSTEM AND METHOD FOR USE IN GROUPING REQUESTERS

(71) Applicant: Brant A. Feldman, Virginia Beach, VA (US)

(72) Inventor: Brant A. Feldman, Virginia Beach, VA (US)

(21) Appl. No.: 15/191,131

(22) Filed: Jun. 23, 2016

Related U.S. Application Data
(60) Provisional application No. 62/183,572, filed on Jun. 23, 2015.

(51) Int. Cl. G06Q 30/08; G06Q 40/04; G06Q 30/06

(52) U.S. Cl. CPC G06Q 30/08; G06Q 30/0605; G06Q 40/04

(57) ABSTRACT

Some embodiments provide systems and method of establishing competitive seller markets, comprising: establishing a first product group exclusively associated with a first product; providing potential buyers with access to group build interface information; receiving requests from a plurality of buyers requesting to join the first product group; joining the plurality of buyers to the first product group; providing potential sellers with access over the distributed network to group bid interface information; and receiving a plurality of different seller bids requesting to be selected as the seller for the first product group.

This application claims the benefit of U.S. Provisional Application No. 62/183,572, filed Jun. 23, 2015, entitled SYSTEM AND METHOD FOR USE IN GROUPING REQUESTERS, for Brant A. Feldman, which is incorporated in its entirety herein by reference.

### BACKGROUND

1. Field of the Invention

The present invention relates generally to network services, and more specifically to distributed network services.

2. Discussion of the Related Art

Individuals purchase products from supplies or sellers. Typically, a buyer identifies a product desired, and then goes to a store to purchase the product from the store. In some instances, buyers actively identify a specific product from a specific manufacturer. Then the buyer goes to a store that carries that specific product or contacts the specific manufacturer.

### SUMMARY OF THE INVENTION

Some embodiments provide methods of distributing products, comprising: establishing, through a group generation service implemented through a cooperative network of computational servers distributed over a wide area distributed network, a first product group exclusively associated with a first product in response to a request from a first buyer; providing hundreds of thousands of potential buyers with access over the distributed network to group build interface information that allows potential buyers to communicate requests over the distributed network to join the first product group; receiving requests from over the distributed network from a plurality of buyers in accordance with the group build interface information each requesting to join the first product group and agreeing, along with each member of the first product group, to purchase at least one of the first product through the first product group; joining the plurality of buyers to the first product group in response to the requests; providing thousands of potential sellers with access over the distributed network to group bid interface information configured to allow potential sellers to communicate seller bids over the distributed network requesting to be selected as a seller of the product to the first product group; and receiving, from a plurality of potential sellers in accordance with the bid interface information, a plurality of different seller bids requesting to be selected as the seller for the first product group, wherein each seller bid of the plurality of different seller bids specifies a seller bid price at which the corresponding seller is willing to sell the first product to members of the first product group.

Other embodiments provide methods of distributing products, comprising: establishing a group generation service implemented through a cooperative network of computational servers distributed over a wide area distributed network and accessible by hundreds of thousands of potential buyers over the distributed network; establishing, through the group generation service, a first product group exclusively associated with a first product in response to a request from a first buyer; allowing access, over the distributed network, to group build interface information that allows potential buyers to communicate requests over the distributed network to join the first product group; and joining a plurality of buyers to the first product group in response to requests received in accordance with the group build interface information from each of the plurality of buyers requesting to join the first product group and agreeing, along with each member of the first product group, to purchase at least one of the first product at a group price.

Some embodiments provide methods of establishing a competitive seller market, comprising: establishing multiple different groups each exclusively associated with a different product requested by members of each of the multiple groups to be purchased by the members of the respective multiple groups; providing thousands of potential sellers with access, through a cooperative network of computational servers dispersed over a distributed network, to bid interface information, wherein the bid interface information identifies a first product exclusively corresponding to a first group of the multiple groups and exclusively established for the first product with each buyer of a plurality of different buyers that have joined the first group requesting to purchase the first product at a price that is not greater than a maximum group price, and the bid interface information is configured to allow one or more of the thousands of potential sellers to present a seller bid requesting to sell the first product to members of the first group; receiving, over the distributed network and in accordance with the bid interface information, a plurality of seller bids from two or more of the potential sellers, wherein each of the plurality of seller bids comprises a seller bid price specifying a price at which a corresponding seller is willing to sell the first product to one or more buyers of the first group; identifying that a first seller bid price specified in a first seller bid from a first seller of the plurality of seller bids is a lowest seller bid price and that at least a first seller specified minimum number of the first product is agreed to be purchased through the first group by the plurality of buyers of the first group; and setting the first seller bid price as a group price that the members of the first group are to pay to purchase the first product when the first seller bid price is less than the maximum group price, is a lowest bid price of all bid prices received from sellers requesting to supply the first product and that have seller specified minimum numbers of the first product that are equal to or less than a number of the first product agreed to purchase through the first group by the plurality of buyers of the first group.

Still further, some embodiments provide systems configured to establish a competitive supplier market, comprising: a group generation service configured to establish and maintain multiple different product groups wherein each product group corresponds to a different product requesting to be purchased by members of each respective product group, wherein the group management module comprises: group build interface circuitry configured to maintain buyer interface information and allow access to the buyer interface information over a distributed network by hundreds of thousands of potential buyers, and further configured to receive information from requesting buyers regarding products requesting to be purchased; group build circuitry communicationally coupled with the group build interface circuitry, wherein the group build circuitry is configured to receive, through the group build interface circuitry, a request from a first buyer identifying a first product that the first buyer desires to purchase, wherein the first product is not available for purchase through the group generation service at the time the request from the first buyer is received, and the group build circuitry is further configured to establish a first product group exclusively associated with the first product in response to the request from the first buyer, wherein the group build circuitry comprises: information collection circuitry configured to obtain researched product information including a cost to purchase the first product from one or more other potential product suppliers that are not associated with the group generation service with respect to the first product; and pricing circuitry configured to determine a maximum group price for the first product based at least in part on the researched product information, wherein the maximum group price is less than a cost to purchase the first produce from one or more of the other potential product suppliers; wherein the group build circuitry is further configured to direct the group build interface circuitry to allow access, by the hundreds of thousands of potential buyers over the distributed network, to group build interface information that allows potential buyers to communicate requests to join the first product group, and to join to the first product group one or more buyers requesting to join the first product group and agreeing, along with each member of the first product group, to purchase at least one first product at a group price equal to or less than the maximum group price.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 shows a simplified flow diagram of an exemplary process of collectively associating multiple potential buyers into a group of buyers requesting to purchase a desired product and/or service, in accordance with some embodiments.

FIG. 2 shows a simplified block diagram of an exemplary group generation and/or build service and/or system, in accordance with some embodiments.

FIG. 3 shows a simplified flow diagram of an exemplary process of building a product group of buyers expressly associated with a particular product or specific collection of products, in accordance with some embodiments.

FIG. 4 shows a simplified flow diagram of an exemplary process of establishing a competitive seller market and/or obtaining seller bids or requests to be the supplier of a particular product to a product group, in accordance with some embodiments.

FIG. 5 shows a simplified flow diagram of an exemplary process of building a group and/or joining buyers to a group, in accordance with some embodiments.

FIG. 6 shows a simplified flow diagram of an exemplary process of modifying and/or updating a group price of a product group, in accordance with some embodiments.

FIG. 7 shows a simplified flow diagram of an exemplary process of closing a group and initiating a sale of one or more products, in accordance with some embodiments.

FIG. 8 shows a simplified flow diagram of an exemplary process of maintaining group build interface information and bid interface information, and providing access to the group build interface information and the bid interface information.

FIG. 9 shows a simplified flow diagram of an exemplary process of maintaining group build interface information and bid interface information, and providing access to the group build interface information and the bid interface information.

FIG. 10A shows a simplified block diagram of an exemplary displayed product group user interface, in accordance with some embodiments.

FIG. 10B shows a simplified block diagram of an exemplary displayed product group user interface, in accordance with some embodiments.

FIG. 11 illustrates an exemplary system for use in implementing methods, techniques, devices, apparatuses, systems, servers, sources and the like in providing user interactive virtual environments in accordance with some embodiments.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” “some embodiments,” “some implementations” or similar language means that a particular feature, structure, or characteristic described in connection with the embodiment is included in at least one embodiment of the present invention. Thus, appearances of the phrases “in one embodiment,” “in an embodiment,” “in some embodiments,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Some embodiments provide systems and methods of associating potential requesters or buyers to create collections of requesters or buyers. These collections of buyers can establish a market due to an increased number of products and/or services desired. As such, sellers have an increased incentive to sell to a collection of buyers due at least in part to the increased number of sales.

Further, some embodiments provide systems and methods configured to allow potential sellers or suppliers to compete to be selected as the supplier of a guaranteed quantity of a product by cooperating requests into a mass or group and thereby guaranteeing to these potential sellers a relatively large quantity of a sale. Accordingly, the some embodiments allow a collection of potential buyers or requesters, and typically unrelated potential buyers, that are each requesting to acquire the same product, to join together to establish a larger group that guarantees to potential sellers or suppliers that they want to purchase a relatively large quantity of the particular product. As such, instead of individual sales a potential seller is guaranteed a relatively large sale and accordingly is more likely to agree to a reduce profit per product because of the guaranteed relatively larger sale. This established larger group of a guaranteed sale incentivizes potential sellers to compete to be selected as the supplier that is guaranteed to supply the larger number of the requested product to the members of the group. As such, the collection of requests allows the group to create a market for potential suppliers to satisfy a larger guaranteed sale.

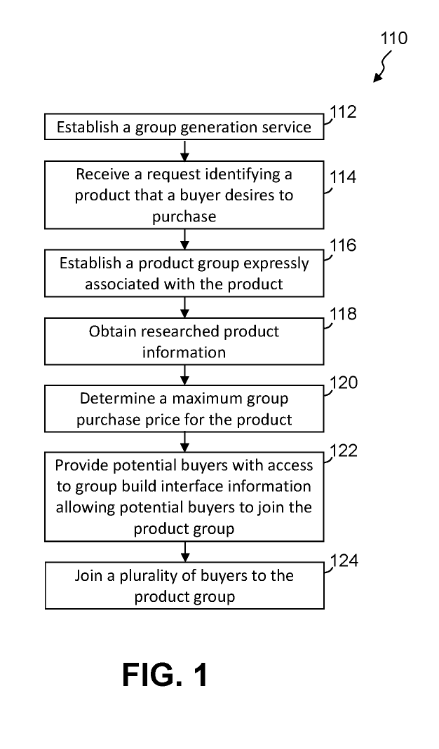

FIG. 1 shows a simplified flow diagram of an exemplary process 110 of collectively associating multiple potential buyers into a group of buyers requesting to purchase a desired product and/or service, in accordance with some embodiments. It is noted that for simplicity, the below description generally refers to a product associated with a group; however, it will be appreciated that a service and/or multiple products or services can equally be requested, bid upon and/or sold through a group build and/or generation service. In step 112, a group generation and/or build service is established through a cooperative network of computational servers distributed over a wide area distributed network and accessible by hundreds of thousands or more of potential buyers over the distributed network. In step 114, a request from a buyer is received at the group generation service and from over the distributed network. The request identifies a product that the buyer desires to purchase. Further, the product is typically not available for purchase through the group generation service at the time the request from the buyer is received, and is not associated with any of a plurality of existing groups that each correspond to a different product that members of the respective groups are requesting to purchase.

In step 116, a product group is established in response to the request from the buyer and the first product group is exclusively associated with the requested product. This product group is distinct and separate from multiple other product groups that are each exclusively associated with different products. Some embodiments further include step 118 where product information is obtained through an evaluation of information provided by the requesting buyer, through research of one or more sources (e.g., advertising, Internet sites, contact with one or more sources, etc.), and/or other such information. In some implementations, some or all of the research is at least partially performed automatically through information collection circuitry, one or more research modules and/or applications of the group generation service. Additionally or alternatively, some of the research may be performed by one or more technicians and/or employees of the group generation service, a third party service and/or other sources. The research can include evaluating potential pricing of the desired product, confirming a specific product, distinguishing the specific product from other similar or related products (e.g., based on size, quantity, color, pattern, etc.), price comparisons, product identification and/or identifier information (e.g., bar code, name, size, quantity, etc.), and/or substantially any other relevant research information. Typically, the researched product information includes at least a cost to purchase the product from one or more other potential product suppliers that are not associated with the group generation service at least with respect to the requested product.

In step 120, a maximum group purchase price (or sometimes referred to as the maximum group price) is determined for the product and specifies a maximum group price that members of a group exclusively associated with the requested product would have to pay to purchase the product as part of the group. Further, the maximum group price is used in evaluating potential sellers' offers and/or bids to sell the desired product to members of the group. In some instances, the maximum group price defines a limit that bid prices of each of the plurality of seller bids has to be less than to be consider as a valid bid. In some embodiments, the maximum group price is determined based at least in part on the researched product information, wherein the maximum group price is typically less than a cost to purchase the first produce from one or more other potential product suppliers. Additionally or alternatively, in some embodiments, the maximum group price to purchase the requested product through the corresponding group is determined based at least in part on an anticipated quantity of the product expected to be purchased through the group and/or an anticipated size of the first product group. For example, in some implementations, when it is anticipated that members of a group will request a threshold number of the corresponding product, the maximum purchase price may be determined and/or calculated at a relatively significant discount over prices to acquire the product from other sources because of the anticipated relatively large volume of the product that is expected to be purchased through the group. Typically, the maximum group buy price is set at a price less than other identified pricing from other selected and/or reputable sources that are identified based on the research information. For example, the Maximum Buy Price can be set at a percentage less than a lowest identified price from a reputable source, set at a predefined amount below a lowest identified price from one of a preselected set of potential sources of the product, or other such discounts. In some embodiments, the maximum group price is set two percent (2%) to five percent (5%) below the lowest advertised price identified by the buyer initiating a product group, while in other instances the percentage discount may vary depending on one or more factors, such as pricing, shipping, expected number of purchases, and the like.

In step 122, potential buyers are allowed access, over the distributed network, to group build interface information that allows the potential buyers to communicate requests over the distributed network to join the first product group. In many embodiments, group build interface circuitry and/or modules distribute user interfaces and/or distribute group build interface information that is utilized to populate at least portions of a user interface displayed and/or generated at buyer devices (e.g., computers, cell phones, tablets, laptops, smart phones, etc.), such as through an application (APP), software, program interface, or the like. For example, a potential buyer may access the group generation service (e.g., through access over the Internet with one or more of the computational servers of the cooperative network) and obtain web page(s), group build interface information and/or other information to be displayed through a user interface that allows a user to identify a group corresponding to a particular product of interest to consider whether to join the group and/or to join the group in requesting to purchase the corresponding product. As another example, a potential buyer may access the group generation service and obtain information to be displayed through a user interface that allows a user to request that a group be generated corresponding to a particular product of interest.

In step 124, a plurality of buyers are associated with and/or joined to a product group corresponding to a particular product in response to requests received in accordance with the group build interface information from each of the plurality of buyers requesting to join the product group and agreeing, along with each member of the product group, to purchase one or more of the corresponding product at a group price that is equal to or less than the maximum group price. In many instances, the group price is based on a request or bid from a potential seller offering to supply the requested products to members of the corresponding product group at a price that is at or below the maximum group price. Requesting buyers are joined to a product group exclusively associated with a specific product (or a specific collection of products) in response to receiving requests from the plurality of buyers requesting to join the group and agreeing to purchase the product at a price that is not more than, and could be less than, a currently designated group price that is not greater than the maximum group price. In some embodiments, an identifier of each of the multiple different buyers is associated with the product group. Further, each of the multiple different buyers is typically notified that she/he is added to the product group as is a member of the group.

Accordingly, the group generation service allows hundreds of thousands of unassociated and/or independent potential purchasers, which are typically geographically distributed and have access to the distributed network, to access product group information for numerous different products and join one or more of these groups to establish a mass of purchasers agreeing to purchase a relatively large number of a desired product. Further, the group generation service allows multiple potential buyers requesting to purchase a desired product to be cooperatively joined together into a group in establishing a mass of buyers and cooperatively establishing through the mass of buyers an enhanced market interest for an increased number of the product. The enhanced market interest for the desired product established through the cooperative collection of the remotely distributed and unassociated requesting purchasers incentivizes one or more potential sellers to bid or request to sell the desired product at a reduced price and/or reduced profit margin at least in part because of a relatively large guaranteed number of sales of the product to the members of the product group.

Once a product group is established and one or more potential buyers are joined, thousands of potential sellers or more are provided with access over the distributed network to group bid interface information configured to allow potential sellers to communicate seller bids over the distributed network requesting to be selected as a seller of the product to the first product group. Further, one or more different seller bids are received from one or more potential sellers in accordance with the bid interface information. The different seller bids request to be selected as the seller for one of the product groups (e.g., multiple different seller bids are received for the first product group). Each seller bid of the plurality of different seller bids specifies a seller bid price at which the corresponding seller is willing to sell the first product to members of the first product group.

Typically, a product group is maintained open for a period of time allowing additional potential buyers to join in the group. In some implementations, the product group is maintained open to allow potential sellers to submit requests or bids to sell the desired product to one or more members of the group at a seller specified sell or bid price. In some embodiments, the group is closed and a sale by one or more sellers is initiated to one or more members of product group for a number of the product that the group agreed to purchase and/or that the one or more sellers have agreed to supply.

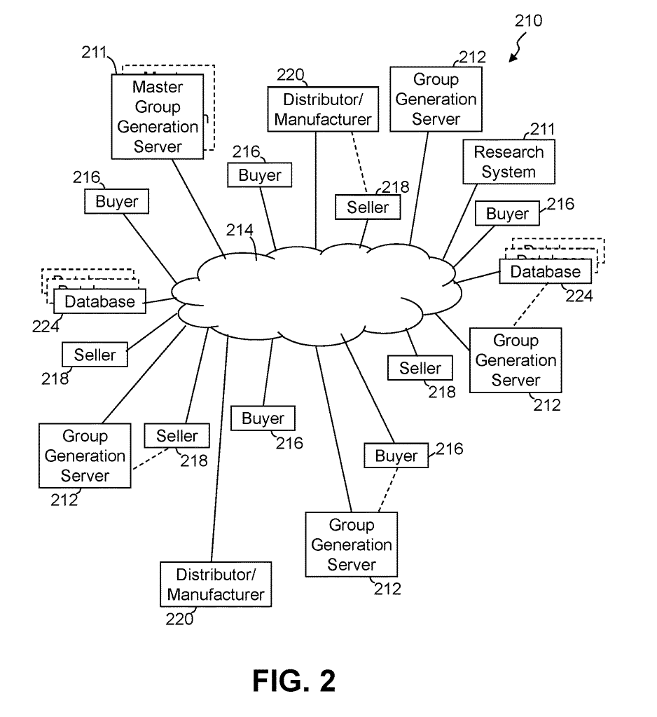

FIG. 2 shows a simplified block diagram of an exemplary group generation and/or build service 210 in accordance with some embodiments. The group generation service 210, in some implementations, includes a plurality of computational group generation servers 212 dispersed over a distributed wide area network 214 that are accessible over the distributed network by numerous potential buyers through buyer devices and/or systems 216 (e.g., computers, cell phones, smart phones, laptops, tablets, network enabled televisions, and other such devices and/or consumer electronic devices) and potential sellers through similar seller devices and/or systems 218. Accordingly, in some embodiments, the buyer devices and/or seller devices are communicationally coupled with the group generation services via the distributed network 214. The buyer devices and/or seller devices are typically distributed over the network and further are typically geographically distributed. In some embodiments, one or more buyers (through buyer devices 216) and/or sellers (through seller devices 218) may directly communicate with one or more of the group generation servers.

In some embodiments, the group generation servers 212 are configured to communicate with each other over the distributed network 214 and/or directly, and provide a cooperative network of computational servers that operate as a single service. Further, one or more of the group generation servers 212 can operate as redundancy to one or more of the other of the group generation servers. In some implementations, some or all of the functionality provided by the group generation service 210 is duplicated at each group generation servers. Additionally, the group generation servers are typically geographically distributed from one another. Some embodiments include one or more master servers 211 and/or one or more of the group generation servers 212 may operate as main, central or master server(s). The master server can be configured with circuitry to provide control over one or more of the group generation servers 212, coordinate operation and/or network traffic (e.g., network traffic from potential buyers, potential sellers, databases, manufacturers, information sources, databases, and/or other such network traffic) between group generation servers, provide relevant information to the other of the group generation servers and other such functions. For example, in some embodiments, the master server maintains information about products offered for sale, buyers, sellers, and the like. Typically, the group generation servers maintain pricing tiers, quantities available, maintains bid functionally and communicates pricing to buyers and sellers, and other such functionality.

Cooperatively, the group generation servers 211, 212 operate to allow buyers 216 to access group build interface information and sellers to access seller interface information and/or group bid interface information. As introduced above, in some embodiments one or more of the group generation servers 212 distribute group bid interface information configured to be used by software and/or APPs in populating a user interface, and/or to distribute user interfaces over the distributed network 214 to be displayed through buyer devices or seller devices. The interface information and/or the interfaces can allow buyers and sellers to access information regarding products of interest and corresponding groups exclusively associated with corresponding products, and/or submit requests to start a group. Additionally or alternatively, the group generation servers can be configured to generate and distribute bid user interfaces using bid interface information and/or to distribute bid interface information that may be used to populate a seller user interfaces displayed through a seller device and/or system. For example, an APP on a tablet or smart phone of a potential buyer may locally generate a user interface (e.g., with options that can be activated through the touch screen of the smart phone, images, photos, product information, product specifications, product identification information, pricing, group information (e.g., number of members in a group, number of products agreed or requested to be purchased through the group, number of products remaining to establish a group, number of products remaining needing to be agreed to be purchased before a specific sell prices is reach, time remaining before the group closes, and/or other such information), or other such information, or combinations of such information. For example, a potential seller may access the group generation service (e.g., through access over the Internet with one or more of the computational servers of the cooperative network) and obtain web page(s), bid interface information, and/or other information to be displayed through a user interface that allows a user to identify a group corresponding to a particular product of interest to consider whether to join the group in requesting to purchase the corresponding product and/or submit a seller bid.

Typically, the potential buyers 216 are unassociated with each other and/or independent of each other. In some instances, two or more of the potential buyers may know each other (e.g., are friends, members of the same family, part of an association, part of a social organization, etc.); however, the buyers submit independent requests to start and/or join one or more groups to purchase one or more of the corresponding desired products. Still further, the buyers are typically distributed over a relatively large geographic area or areas (e.g., over a city (e.g., when a product is associated with the city), over county or parish, over a state, over a country, and/or often over multiple states and/or countries, etc.).

The sellers 218 may be a manufacturer, a distributor, an authorized retailer, an individual entity unassociated with a manufacturer or distributor, and/or substantially any other potential seller. In some embodiments, one or more sellers may be in communication directly and/or indirectly (e.g., through the distributed network 214) with one or more manufacturers and/or distributors 220. Similar to buyers 216, the sellers 218 are typically unrelated and typically submit bids independent of each other.

In some embodiments, one or more databases 224 may be accessible, directly and/or through the distributed network 214, by one or more of the group generation servers 212, sellers 218 and/or the distributors or manufacturers 220. For example, in some implementations, the group generation service 210 includes one or more databases 224 that store one or more of buyer information, seller information, product information, research information and/or other such information. Additionally or alternatively, databases 224 may be maintained by third parties and accessed by one or more of the group generation servers 212. Further, some embodiments may include information collection circuitry and/or research system 226, module, circuitry that in part is configured to implement and/or save results of searches for product information and/or pricing. In some instances, some or all of the research system may be implemented by a third party used by the group generation service.

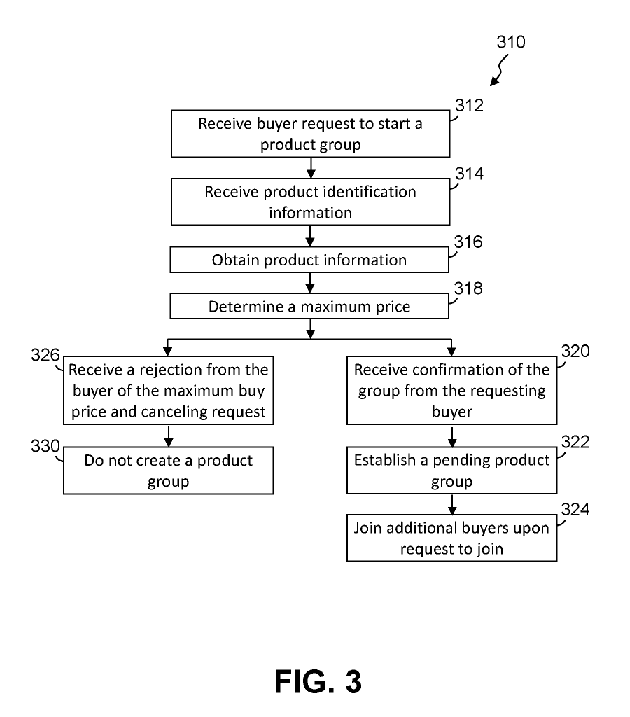

FIG. 3 shows a simplified flow diagram of an exemplary process 310 of building a product group of buyers expressly associated with a particular product or specific collection of products, in accordance with some embodiments. In step 312, an initial buyer request is received requesting that a product group be started for a particular product or service (or specific collection of products or services) that the buyer desires to purchase through the group generation service 210. Again, as described above and further below, the buyer typically accesses the group generation service 210 through the distributed network. The one or more group generation servers 212 supply relevant buyer interface information, which in some instances is group build interface information and/or includes information to populate group build interface information. The group build interface information allows the user to communicate with the group generation service 210 to submit the request and identify the product the buyer wants to purchase.

In step 314, product identification information is received corresponding to the particular product. In some instances, some or all of the product identification information is provided by the potential buyer. For example, in some implementations, the potential buyer provides a product name, bar code and/or other such relevant identifying information. Further, the product identification information may additionally or alternatively include information such as but not limited to product size (e.g., sizing information (e.g., small, medium, large, extra-large, petite, etc.), weight, dimensions, and/or other such information), quantity within a package, quantity of the product, a product department or category with which the product may be associated (e.g., specified by the potential buyer, selected through a user interface from a listing of departments provided by the group generation service, etc.), one or more product sub-departments or sub-categories, manufacturer's name, model number, and/or other such information or combinations of such information.

Some embodiments further include step 316, where product information is obtained. In some instances, the product information includes pricing from one or more sources (the sources may be associated with the group generation service or unassociated with the group generation service), one or more sources for additional information (e.g., manufacturer website, website associated with the requested product, third party website, etc.), shipping information, and/or other such information. The product information may be supplied by a potential buyer (e.g., potential buyer requesting the group be activated), obtained through internal research, obtained through third party research, and/or other sources. For example, in some implementations, the requesting potential buyer provides product information, such as but not limited to pricing, one or more product sources, website information, and the like. The potentially buyer, in some instances, may further provide a part number, product description, one or more product images, and/or other such information when available.

Some embodiments include information collection and/or research circuitry implemented as a stand-alone system in communication with one or more group generation servers 212 and/or implemented on one or more group generation servers. Further, the information collection circuitry can be implemented through one or more computers, processors, databases, other memory or combinations thereof. In some embodiments, the information collection circuitry comprises one or more processors having access to processor readable and/or computer readable memory storing programming, code, firmware, executables, data, information or the like, or combinations thereof. Similarly, in some implementations, the information collection circuitry comprises multiple processors distributed over a network (e.g., the Internet) and in communication over the network or another network to provide cooperative operation. Additionally or alternatively, some embodiments comprise one or more computers accessible by operates of the group generation service and/or one or more third party services that initiate and/or perform research, data collection or a combination thereof. The information may be stored on databases, obtained through Internet searches, determined from periodicals, advertisements and/or other sources.

In step 318, a maximum group price is determined. Typically, the maximum group price is based on pricing of the product from one or more sources not associated with the group generation service. For example, in some instances, an Internet search is conducted for the product and one or more potential suppliers of the product may be identified and corresponding pricing to acquire the product from the source. In some implementations, an analysis is performed on the research information to determine the maximum group price. This analysis can include an estimate of a number of potential buyers that may join the group, a number of the product that may be distributed by one or more sources within a given period of time, historical data (e.g., history of previous sales, history of demand, history of a number of bids and/or a competitiveness of bids, etc.), and/or other such information.

The maximum group price is typically selected at a value that is below prices from many if not most of identified third party sources, and in some instances is set at a percentage less than a lowest price specified from a reputable supplier (e.g., regional or nationwide stores and/or websites associated with such stores, website with some guarantees, large volume distributors and/or websites, and/or other such reputable suppliers). The percentage reduction may depend on one or more factors, such as but not limited to, types of sources, manufacturer, predicted group size and/or number of products predicted to be sold through the group, a relationship the group generation service has with one or more suppliers of the requested product, and/or other such factors (such as some or all of the factors identified above or below). As an example, a percentage reduction of at least about 2-5% of a minimum price from a reputable source may be selected, and in some instances a greater percentage reduction is specified. Again, the maximum group price sets a maximum purchase price that members of a group exclusively associated with the requested product would have to pay to purchase the product as part of the group, while the group generation service attempts to obtain pricing bids from one or more potential sellers that are below the maximum group price. Furthermore, the evaluation of factors and/or the consideration of some factors may be dependent on other factors and/or weighting of factors may be applied and/or applied based on other factors. Some embodiments set a maximum group price range (e.g., from two percent (2%) to five percent (5%)) below an identified advertised price, which may include shipping. Often, before the group is confirmed and submitted, the buyer submitting the request for the group has to approve the price range. The maximum group price can then be set within this range based on one or more factors, such as those identified above and/or below.

In step 320, some embodiments optionally request and receive a confirmation from the initial requesting potential buyer that the potential buyer intends to join the group at the maximum group price for the identified product. It is noted that in some instances, the requesting buyer may feel the maximum group price is not set low enough and as such may reject the establishment of a group based on the maximum group price. Accordingly, some embodiments include step 326 where the rejection is received from the potential buyer rejecting the potential group and/or the maximum group price. In some instances, step 330 is implemented where the rejection by the potential buyer is considered a cancellation of the request to initiate a group, while in other instances, the rejection may induce further evaluation of the proposed maximum group price and/or the research may be initiated and/or further research and/or evaluation of research may be performed (e.g., returning to step 316 and/or 318).

In step 322, a pending product group is established specific to the requested product. The pending product group is typically maintained as open for at least a predefined period of time, which may depend on many factors, such as information from the initial requesting buyer, the maximum group price, predicted number of potential buyers, type of product requested, number and/or type of potential sellers, and/or other such information (such as one or more of the factors described above or below). Some embodiments utilize a default group open time period (e.g., 72 hours). The open time period can be extended (e.g., extended to 96 hours, 120 hours or longer) or shortened. The open time can be extended based on the relative cost of the item, number of buyers likely needed to reach a discount, and/or other such factors. In many instances, the open time period is set longer as pricing of the product increases (e.g., above threshold levels), the number of buyers needed to achieve certain threshold group size levels, or other such factors or combinations of such factors. In step 324, one or more additional buyers are joined to the group in response to subsequent requests from the one or more additional buyers to join the group.

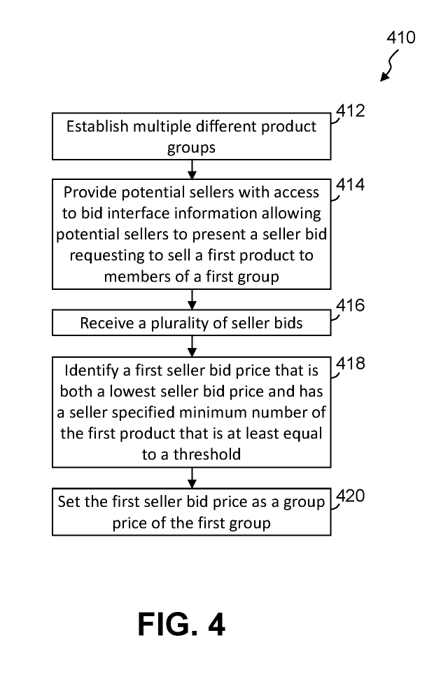

FIG. 4 shows a simplified flow diagram of an exemplary process 410 of establishing a competitive seller market and/or obtaining seller bids or requests to be the supplier of a particular product to a product group, in accordance with some embodiments. In step 412, multiple different groups are established that are each exclusively associated with a different product (or specific collection of products) requested by members of each of the multiple groups to be purchased by the members of the respective multiple groups. For example, multiple product groups are established consistent with the process 310 of FIG. 3.

In step 414, thousands and typically tens of thousands of potential sellers or more are provided with access to bid interface information. The potential sellers are typically provided access to the bid interface information through a cooperative network of computational servers (e.g., the group generation servers 212) dispersed over the distributed network 214. Some embodiments comprise seller bid interface circuitry and/or modules configured to receive requests for interface information, identify relevant seller bid interface information and distribute seller bid interfaces and/or distribute seller bid interface information that is utilized to populate at least portions of a seller bid interface displayed and/or generated at the potential seller devices (e.g., computers, tablets, cell phones, laptops, smart phones, etc.), such as through an application (APP), software, program interface, or the like. In some implementations, the seller bid interface circuitry comprises one or more processors communicationally coupled with one or more processor readable and/or computer readable memory storing firmware, software, executables, data, information, parameters and the like used in generating and/or distributing the seller bid interface information and/or the seller bid interfaces. The seller bid interface circuitry, in some embodiments, is implemented as a stand-alone system in communication with one or more group generation servers 212 and/or implemented on one or more group generation servers.

Potential sellers may access the group generation service and/or the seller bid interface circuitry (e.g., through access over the Internet with one or more computational servers and/or group generation servers of the cooperative network) and obtain web page(s), bid interface information, and/or other information to be displayed through a seller bid interface that allows a potential seller to identify a group corresponding to a particular product, consider whether to submit a bid and allow the seller to submit a bid requesting to be the supplier of the particular product to one or more of the members of the group. In some embodiments, the bid interface information identifies a first product exclusively corresponding to a specific group of the multiple different groups and exclusively established for the first product with each buyer of a plurality of different buyers that have joined a group requesting to purchase the first product at a price that is not greater than a maximum group price. The bid interface information is configured to allow one or more of the thousands or more of potential sellers to present a seller bid requesting to sell the first product to members of the group.

In step 416, one or more seller bids from one or more of the potential sellers are received, and often multiple seller bids are received from multiple different potential sellers. Typically, the seller bids are received from over the distributed network 214 and in accordance with the bid interface information. Further, each seller bid comprises a seller bid price that specifies a price at which a corresponding seller is willing to sell the product to one or more buyers of the group for which the bid was submitted. In some instances, the seller bid price is merely the cost to purchase the product, and does not include other costs associated with the purchase from the seller, such as but not limited to taxes, shipping costs, fees and/or other such costs. In other instances, the seller bid price may include some or all of the other costs and/or may include some costs with some conditions (e.g., include certain taxes, shipping within certain regions, credit card fees for some credit cards, transfer fees from some third party services, and/or other such conditional costs).

In step 418, one of the seller bid prices of the plurality of seller bids (e.g., a first seller bid price) specified in a seller bid from a seller (e.g., specified in a first bid from the first seller) is identified as a lowest seller bid price. Further, in some embodiments, it is determined and/or confirmed that a number of the first product agreed to be purchased through the first group by the plurality of buyers of the first group is at least equal to a seller specified minimum number of the corresponding product. The minimum product number threshold corresponds to a minimum threshold number of the product set by the potential seller, typically in the seller bid, that specifies a minimum number of the product that the seller is agreeing to sell to the group at the seller bid price. This allows the potential seller to ensure that sufficient sales are achieved to obtain a sufficient revenue and/or profit from the sale to the group at the seller bid price. For example, in some instances, it is identified that at least the seller specified minimum number of the product is agreed to be purchased through the group by the plurality of buyers of the group.

In step 420, the first seller bid price is set as a group price that the members of the first group are to pay to purchase the product when the seller bid price is less than the maximum group price, is a lowest bid price of all bid prices received from potential sellers requesting to supply the product and that have seller specified minimum numbers of the product that are equal to or less than the quantity or number of the product agreed to be purchased through the first group by the plurality of buyers of the first group. Accordingly, a seller bid price is selected and members of the group have agreed to purchase the product for at least the seller bid price.

In some embodiments, one or more seller bids that are not selected as the group seller may be held in reserve. The reserved bids can be used as potential sell bids in an event where the selected group seller cannot fulfill all of the requested products (e.g., does not have sufficient stock and/or has a specified maximum number of products that is exceeded by the requesting buyers), and/or a non-selected bid has a seller specified minimum number that has not been reached by the group. As such, in some instances multiple seller bids may be selected to satisfy the all of the requests from the buyers. Further, some buyers may have to pay different prices than other buyers and/or a single buyer may have to pay different prices when requesting more than one product depending on the seller selected to satisfy the sale.

In some embodiments, the process 410 and/or portions of the process 410 can be continuously repeated for one or more of the groups while each group remains open to potentially allow one or more other sellers submit seller bids in trying to underbid the current price and be selected as the selling entity. The result of the underbidding allows members of the group to purchase the product corresponding to the group at an even greater discount. Further, maintaining the group open and allowing subsequent seller bids least in part establishes a competitive seller market where sellers bid against each other to be the supplier of the product while buyers take advantage of the competitive underbidding between potential sellers. Additionally or alternatively, this allows a potential seller offering a lower seller bid price to be selected as the selling entity and to set the group price in accordance with the bid price once a number of products agreed to be purchased by the group exceeds that potential seller's specified seller minimum product number. For example, in some embodiments, a second seller bid (e.g., subsequent seller bid) may be received from a second seller after the first seller bid price is set as the group price. The second seller bid and/or second seller bid price can be evaluated at least relative to the first seller bid price (i.e., a currently specified group price). Further, the second seller minimum product number is typically evaluated relative to the number of products currently agreed to be purchased by the members of the group. Again, the second seller bid specifies a second seller bid price that the second seller is willing to sell the first product to the members of the first group. The group price can be set equal to the second seller bid price replacing the first seller bid price as the group price when the second seller bid price is less than the maximum group price and is less than the first seller bid price.

Similarly, some embodiments may reserve one or more seller bids that specify seller bid prices that are lower than the current set group price when the seller specified minimum number of products identified in the bids is greater than the current number of products requesting to be purchased by the members of the group. For example, a second seller bid can be received from a second seller that specifies a second seller bid price at which the second seller is willing to sell the product and further specifies a second seller minimum number specifying a minimum number of the product that the members of the first group must agree to be purchase before the second seller would to be obligated to sell the first product to the members of the first group at the second seller bid price should the second seller be selected as the seller to sell the first product to the one or more members of the group. An evaluation can repeatedly and/or continuously be performed (e.g., steps 416 and 418 can be performed in response to each request from the group to purchase a product and/or in response to receiving a seller bid) to determine and/or identify that a seller bid price (e.g., the second seller bid price in the above example) is a lower bid price than the currently set group price, and identify that the number of the first product requesting to be purchased by the first group is less than the second seller minimum number. Accordingly, the second seller bid can be set as a reserve bid in response to the identifying that the number of the first product requesting to be purchased by the first group is less than the second seller minimum number and determining not to set the second seller bid price as the group price in response.

Some embodiments further provide information to members of the group and/or potential buyers viewing group information (e.g., through the group build interface and/or in accordance with group build interface information). For example, group build interface information, which is accessible over the distributed network, can be provided to one or more potential buyers of the group and/or considering joining the group. Again, the group build interface information is configured to allow buyers to join the first group and agree to purchase the product at set the group price when. In some implementations, the group build interface information is further configured to cause a reduced price notification to be displayed, when accessed and/or implemented by potential buyers, specifying that the product is available to members of the first group at a reduced or lower second seller bid price should the number of the product requested to be purchased by the members of the first group increase to equal or exceed the second seller minimum number. As such, potential buyers may be further incentivized to join a group because of the further reduced price. As described above, set group price can be replaced with the lower bid price when the number of products requesting to be purchased by the members of the group equals and/or exceeds a seller specified minimum product number threshold corresponding to the low bid price. As such, it can be identified that a number of the product agreed to be purchased by the members of the first group has increased to at least equal a second seller specified minimum number, and the group price corresponding to the group is set or reset to equal the second seller bid price replacing a first seller bid price as the group price in response to the identifying that the number of the product agreed to be purchased by the members of the first group has increased to at least equal the second seller minimum number.

Upon closing a group, the seller that is selected the group price is obligated to supply the members of the group with the number of products requested, at least up to a seller specified maximum number of the product specified in the bid, and typically in response to the group generation service and/or the seller receiving payment and/or confirmation that a third party received payment from the relevant members of the group. Some embodiments identify that a number of products requested to be purchased through a group exceeds a first seller maximum number of the requested product that the first seller bid and/or agreed to provide at the seller bid price. A second seller bid can further be identified. In some instances, the second seller bid may have a greater seller bid price. A sale may be initiated of a number of the first product requested to be purchased through the group that was in excess of the first seller maximum number through the second seller at the second seller bid price to fulfill a demand of the first product to the members of the first group that was in excess of the first seller maximum number.

Again, once a group is established that group is typically maintained in an open state for a predefined period of time. In some instances, while the group is open one or more additional potential buyers may join the group agreeing to purchase one or more of the associated product at no more than the maximum group price and typically at the set group price, which is typically less than the maximum group price.

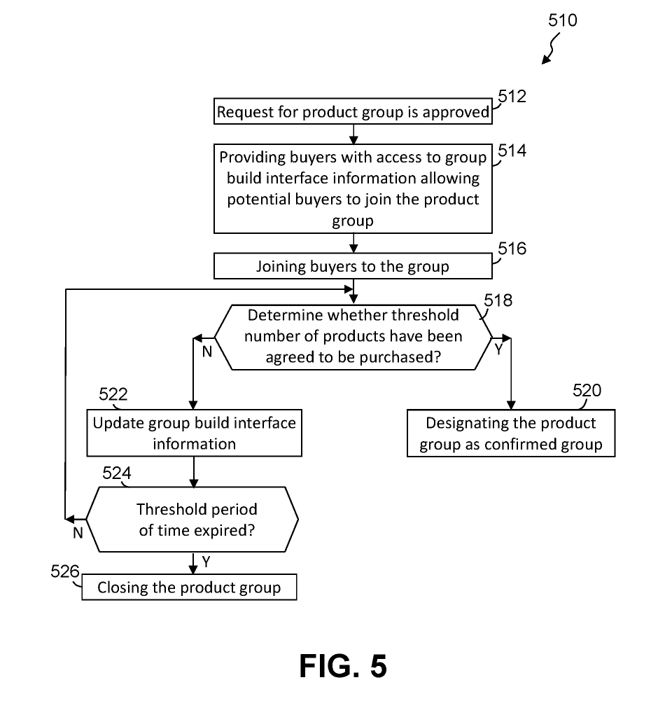

FIG. 5 shows a simplified flow diagram of an exemplary process 510 of building a group and/or joining buyers to a group, in accordance with some embodiments. In step 512, a request from a potential buyer to start a group expressly associated with a particular product and/or group of products is approved. For example, in some implementations, step 512 is implemented through some or all of the steps of the process 310 of FIG. 3. In response to approving the group, a group is established and group build interface information and/or user interface information is compiled and/or generated for the group. In step 514, potential buyers are provided with access over the distributed network 214 to the group build interface information and/or group build user interface. Again, the group build interface information may be configured to cause a user interface to be displayed on a buyer device. Further, the group build interface information is configured to allow the user to view information about the product associated with the group (e.g., one or more images of the product; product specifications, such as but not limited to one or more of size, number, weight, dimensions, materials, contents, color information, options if available, etc.; related products; use; directions; access (e.g., links, drop-down, options, etc.) to other information; information about a manufacturer; reviews and/or access (e.g., links, drop-down, options, etc.) to reviews; and/or other such information), and pricing information. Typically, the pricing information specifies a maximum group price, at least when a group prices has not yet been set. In some instances, pricing information additionally or alternatively includes a group price. Further, pricing information may be included such as but not limited to one or more potential group pricing if a sufficient threshold number of products are agreed to be purchased by the group.

In step 516, one or more potential buyers are joined to the group in response to the potential buyers agreeing to purchase the product at the specified maximum group price and/or a designated group price. In some embodiments, the group generation service 210 acquires buyer information from each member of the group and associates a price with each buyer that the buyer agreed to pay for the product. For example, some implementations have potential buyers register with the group generation service providing user identifying information, password(s), mailing and/or shipping address information, payment information (e.g., credit card information, on-line payment account information, debit card information, a third party holding service, banking information, and/or other such information), preferences, e-mail, wireless phone and/or other contact information, or other such registration information and typically a combination of two or more of such information. Some embodiments include registration circuitry implemented as a stand-alone system in communication with one or more group generation servers 212 and/or implemented on one or more group generation servers. Further, the registration circuitry can be implemented through one or more processors having access to processor readable and/or computer readable memory storing programming, code, firmware, executables, data, information or the like, or combinations thereof. Typically, the registration circuitry comprises multiple processors distributed over a network (e.g., the Internet) and in communication over the network or another network to provide cooperative operation. In some instances, the buyer is charged for the product, while in other embodiments, the buyer is not charged until the group is closed. Still further, in some embodiments, the group build interface information is updated to track the number of buyers that are joined to the group and/or the number of products the one or more members of the group agree to purchase, which can be displayed to the members of the group and/or potential buyers considering joining the group. In some embodiments, the system continuously maintains and updates the information and/or interface information with current numbers of buyers, number of the product/buyers needed to reach a next price break, etc. Similarly, in some embodiments, the current bid price and quantities remaining at that price are continuously updated. The system can further be configured to provide the ability for buyers and/or sellers to share the offer, for example, through email and various social media in order to increase the size of the buyer group. In some embodiments, step 516 includes providing an initial requesting potential buyer that initiated the particular group a notification that the product group was approved and/or providing the requesting buyer with an option to join the group. In other instances, the initial requesting potential buyer is automatically joined to the group and/or joined in response to the initial requesting potential buyer accepting the maximum group price.

In some embodiments, the registration circuitry comprises buyer profile circuitry and seller profile circuitry configured to compile, store and manage profile information of potential buyers and/or sellers. The profile information can include contact information, preferences, history data, links to information, and/or other such relevant information. The buyer profile circuitry and seller profile circuitry, in some instances, comprise one or more processors communicationally coupled with one or more processor readable and/or computer readable memory storing firmware, software, executables, data, information, parameters and the like configured to compile, store and manage profile information. Further, when implemented through multiple processors, the processors may be distributed over a network (e.g., LAN, WAN, Internet, etc.). The buyer profile circuitry and/or seller profile circuitry can be implemented as stand-alone systems in communication with one or more group generation servers 212 and/or implemented on one or more group generation servers.

In step 518, it is determined whether a confirmation threshold number of the product exclusively associated with the group have been agreed to be purchased by potential buyers. The confirmation threshold is typically set at a level to ensure that a sufficient quantity of the product is guaranteed to be purchased to entice potential sellers to submit bids. The confirmation threshold can be determined and/or set based on one or more factors, such as but not limited to the maximum group price, expected seller profit margin, predicted number of products to be sold through the group, predicted number of members of the group, expected number of products potential sellers are predicted to offer, predicted group price, historical data (e.g., sales of the same or similar products, sales of produces from the same or similar manufacturer, previous bids from one or more potential seller for the same or similar products, and other such factors or combinations of such factors), statistical data, other such information, and typically based on a combinations one or more of such factors (such as one or more factors identified above or below). Further, weighting may be applied to one or more of these factors in determining a confirmation threshold. Additionally, in some implementations, the confirmation threshold may be adjusted over time, such as in response to seller bids and/or other such factors. Some embodiments utilize a default quantity value (e.g., a default quantity of five). Statistical data can be utilized to identify retail price breaks and/or set price breaks once threshold quantities are agreed to be purchased (e.g., price breaks available in quantities five (5) and above). This can be adjusted based on the relative cost of the item. In some instances, the higher the relative cost of the product and/or lower quantity demanded could lead to lower confirmation thresholds and/or price break thresholds. Similarly, in some instances, lower cost and/or higher quantity demanded products could lead to a higher confirmation threshold and/or price break thresholds. Further, in some embodiments, one or more thresholds are established at time of group creation.

When the number of products agreed to be purchased by members of the group meet and/or exceed the confirmation threshold, the process advances to step 520 where the approved group is confirmed as an active group. In some embodiments, a threshold time the group is to remain active and open is set in step 520. Similar to the confirmation threshold, this open time threshold can be based on one or more factors, such as but not limited to one or more of those factors used in determining a confirmation threshold and/or other factors. As described above, some embodiments apply a default open time period (e.g., a default open time of 72 hours). The default time can be shortened and/or extended (e.g., extended to 96 hours, 120 hours, or other duration). Further, the default time may be shortened or be extended based on one or more factors, such as the relative cost of the product, number of buyers likely needed to reach a discount, and/or other such factors. For example, in some implementations the greater the cost of a product and/or the larger the number of buyers needed, the longer the open period required. Further, in some embodiments, the open time threshold may be modified over time based on potential buyer demand, numbers of potential seller bids, bid pricing, numbers of products bidding or offering to be provided, number of products requesting to be purchased and/or other such factors. Additionally, some factors may be dependent on other factors and/or weighting of factors may be applied and/or applied based on other factors.

In those instances where the number of products agreed to be purchased by members of the group does not meet and/or exceed the confirmation threshold, some embodiments include step 522 where the members of the group and/or other potential buyers are notified regarding the remaining number of products needed to be requested by the group to meet the threshold. For example, in some instances the group build interface information is updated and when buyers and/or potential buyers access the group build interface information and/or a group build interface is displayed, the number of products short of the threshold is displayed. In step 524, it is determined whether a confirmation time period threshold has expired. In some embodiments, an approved group is maintained as open for the confirmation time period to provide sufficient time for potential buyers to realize and/or access the group and to allow a sufficient number of potential buyers to join the group. In those instances where the confirmation time period threshold has expired step 526 is entered and the product group is closed without a sale of the products to the members of the group. In some instances, the closing of a product group without a sale is considered an unsuccessful product group and/or an unsuccessful closing of a product group.

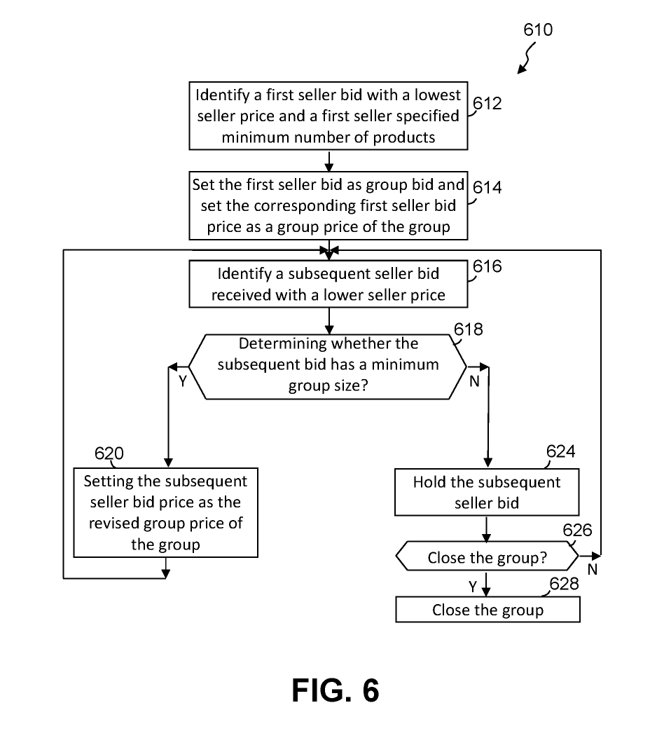

FIG. 6 shows a simplified flow diagram of an exemplary process 610 of modifying and/or updating a group price of a product group, in accordance with some embodiments. In step 612, one or more seller bids are evaluated and a first seller bid is identified that has a current lowest specified seller price and also has a first seller specified minimum number of products that is less than the number of products requested to be purchased by the members of the group, less than a number of members of the group and/or has a minimum number of products that is closest to a current number of products requesting to be purchased by the members of the group. In step 614, the first seller bid is selected as the active group bid and the group price of the group is set to the first seller bid price. In step 616, a second seller bid is evaluated and identified as having a second seller bid price that is less than the group price, and thus the first seller bid price. Typically, the second seller bid is received after the first sell bid price is set as the group price. In step 618, it is determined whether the second bid has a seller specified minimum number and/or minimum group size that is less than a current number of products, at the time of evaluating the second bid price, agreed to be purchased by the members of the group. In those instances where the number of products agreed to be purchased by the group is equal to or greater than the second seller specified minimum number, the process advances to step 620 where the group price is revised or changed to be equal to the second seller bid price. In some embodiments, the process returns to step 616 to continue to evaluate one or more new, pending and/or reserved seller bids.

In some embodiments, when the number of products agreed to be purchased by the group is less than the second seller specified minimum number the process continues to step 624 where the second seller bid is held in reserve and/or maintained as a pending bid. The second seller bid and/or other reserved bids can later be reevaluated, such as in response to a buyer being added to the group as the new buyer agrees to purchase the product at the current group price, which increases the number of products the group has agreed to purchase. In step 626, it can be determined whether the group should be closed. As described above, the group can be maintained open for a period of time (e.g., the open time threshold) allowing potential buyers to review and/or join the group, and/or allow potential sellers to review and/or submit bids for the group. Similarly, a group may be closed in an event where the group fails to agree to purchase a sufficient numbers of products to meet at least one seller's specified minimum number of products within a threshold time. In some embodiments, when the group is not to be closed, the process returns to step 616 and/or 618 to continue to evaluate new and/or reserved seller bids. Alternatively, the group can close the group in step 628, and sales can be finalized when a bid was selected and a group price set corresponding to the bid price, or no sales are completed when the number of products agreed to be purchased by the group fails to meet or exceed at one bid's specified minimum number.

In some embodiments, the determination in step 616 of whether the second seller bid price is below the group price is determined after step 618 and the confirmation that the second seller specified minimum number is less than the number of products agreed to be purchased by the group. Further, in some embodiments, some or all of the process 610 is implemented through the seller bid interface circuitry. In other embodiments, the process 610 is implemented through the group build interface circuitry, the seller bid interface circuitry, other circuitry and/or a combination thereof.

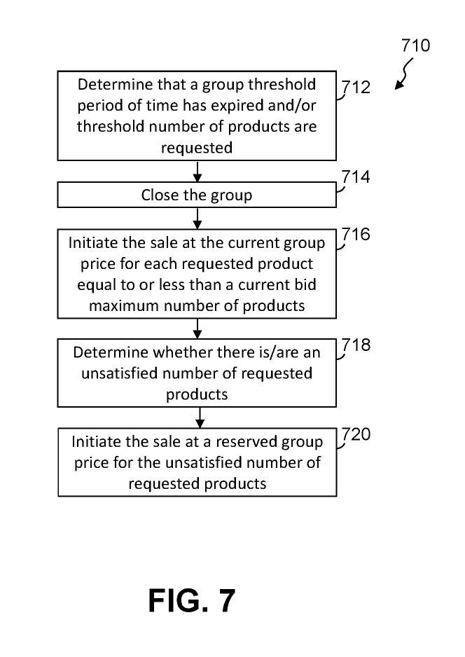

FIG. 7 shows a simplified flow diagram of an exemplary process 710 of closing a group and initiating a sale of one or more products, in accordance with some embodiments. In step 712, it is recognized that a group open time threshold has expired and/or a threshold number of products have been agreed to be purchased by the members of the group. In some embodiments, a group may be maintained as open until a threshold number of products have been agreed to be purchased. For example, when a seller bid specifies a bid maximum number of the product that the seller is willing to and/or capable of selling at the seller bid price. Once this threshold is reached, the group may be closed in some instances.

In step 714, the group is closed such that one or more additional potential buyers cannot join the group. Further, in some embodiments, one or more potential sellers cannot submit a seller bid. In step 716, a sale of one or more products is initiated at the current group price for each requested product that is equal to or less than a current bid's specified maximum number of products. The sale can include charging one or more of the members of the group the final group price for each product they agreed to purchase. Again, the charge can be through a credit card, third party service and the like. In some implementations, the group generation service may notify the seller that the group was closed and instruct and/or allow the seller to initiate charging for the product and any other fees (e.g., taxes, shipping, etc.) that may be needed and/or agreed to by the buyers and/or the group generation service.

As described above, some embodiments, allow a seller to specify a maximum number of the product that the seller is willing to and/or capable of selling at the seller bid price. Accordingly, in some embodiments, the number of products requested by the group may exceed the maximum number of the product specified in the selected bid. Accordingly, some embodiments comprise step 718 to determine whether there is one or more unsatisfied number of the requested products that were requested by the members of the group, and when there are unsatisfied requests whether there are one or more reserved bids that can satisfy one or more of the unsatisfied purchase requests from the group. In those instances where there are unsatisfied requests and reserve bids available that can satisfy those requests, a sale is initiated in step 720 for one or more of the unsatisfied number of the requested products through one or more reserved bids at one or more reserved group prices. In some instances, these reserve bids have bid prices that are greater than the final group price. Further, in some implementations, the selected one or more reserved bids have seller specified minimum numbers that are less than the one or more unsatisfied number of the requested products. Additionally, in some embodiments, the unsatisfied buyers may be notified that their request cannot be fulfilled. Again, typically, the unsatisfied buyers are buyers that joined the group later and as the number of products requested through the group approaches a seller maximum. In some embodiments, once a product group is closed, the group generation service and/or system can be configured to charge each buyer's credit card at the lowest accepted bid price. Once credit card payment has been processed, a purchase order for fulfillment by the seller can be generated. Typically, the seller receives a purchase order for their bid price less a bid fee and/or other costs charged by the group generation service.

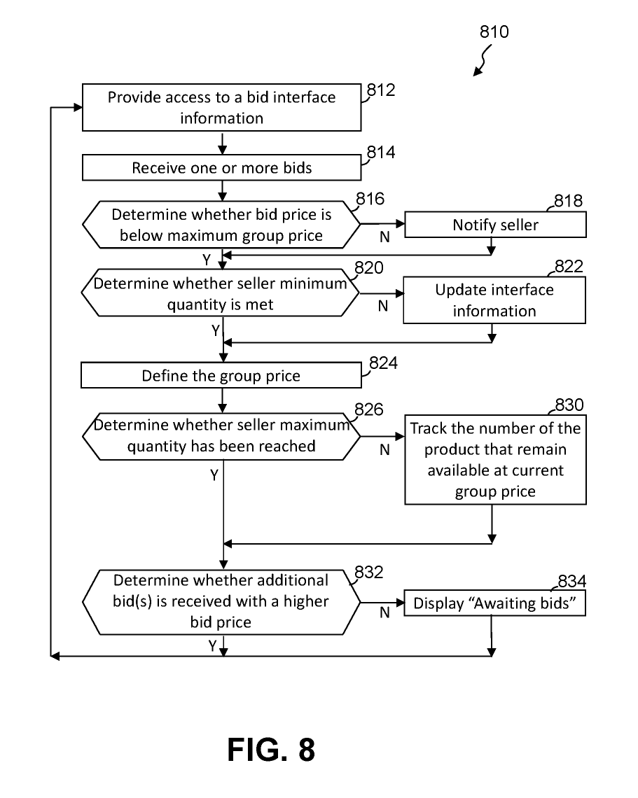

FIG. 8 shows a simplified flow diagram of an exemplary process 810 of maintaining group build interface information and bid interface information, and providing access to the group build interface information and the bid interface information. In step 812, tens of thousands of potential sellers, and in some instances hundreds of thousands of potential sellers or more, are provided access to bid interface information. The bid interface information is configured to be used to generate a user interface and/or distributed over a network to at least populate portions of a seller user interfaces displayed through a seller device and/or system. Further, the seller user interface allows potential sellers to review potential groups and submit one or more bids to be a seller for the product of one or more product groups. In step 814, one or more bids are received from potential sellers requesting to be selected as the source of a product to the one or more product groups.

In step 816, it is determined whether a bid price specified in a bid meets and/or is below a maximum group purchase price designated for the particular product group for which the bid was submitted. Again, the group generation service 210 typically defines the maximum group price, which in many embodiments is determined based on an evaluation of product information and/or pricing of that product from one or more sources. In some embodiments, when a seller bid price is not below the maximum group price the seller is notified in step 818 that the bid price does not comply with the maximum group price. The notification can be through one or more web pages, the disbursement of updated bid interface information, through an email, text message and/or other such methods of notification. Additionally, in some instances, the group build interface information and/or the bid interface information may specify that the group is awaiting bids and such information may be displayed to potential sellers and/or buyers viewing the group. Further, in some implementations, the group generation service may reevaluate the maximum group price was a function of the bid price. For example, in some instances a maximum group price may be adjusted in response to one and typically multiple bid prices being received that exceed the maximum group price, which may indicate a determined maximum group price is inconsistent with the market and/or changing market conditions.

In step 820, some embodiments evaluate the number of products requested to be purchased by members of the group relative to a seller minimum number or quantity of the product that must be agreed to be purchased by the group before a potential seller is willing to sell the product at the corresponding bid price. In step 822, some embodiments update group build interface information and/or bid interface information to identify a number of additional products the group must agree to purchase before a specified bid price becomes the group price. Again, the updated group build interface information and/or updated bid interface information can cause this information to be displayed to members of the group, potential buyers, sellers that have submitted bids, potential sellers, and other parties (e.g., agents and/or employees of the group generation service). Further, the updated group build interface information and/or updated bid interface information can be configured to cause multiple different potential bid prices along with corresponding numbers of product that must be agreed to be purchased by the group before a particular bid price becomes the group price. For example, the group build interface information and/or the bid interface information may include information regarding a first bid specifying a first bid price when a first minimum number of products is agreed to be purchased, and a second bid specifying a second bid price, which is lower than the first bid price, when a second minimum number of products, which is greater than the first minimum number, is agreed to be purchased. As such, this information when displayed to potential buyers and/or sellers may incentivize buyers to join the group and/or sellers to submit bids at lower bid pricing and/or with smaller minimum number restrictions.

In step 824, the group build interface information and/or the bid interface information may include and/or be updated to identify a current group price. Again, this interface information can be configured to display this information to members of the group, potential buyers, and/or potential sellers. Some embodiments may further identify the selected seller and/or seller bid corresponding to the current group price.

In step 826, some embodiments determined whether the number of products requesting to be purchased through the product group equals or is greater than a seller maximum number specified in the currently selected and active seller bid. In step 830, when the number of products requested by the group is less than the seller maximum number some embodiments track this information in the group build interface information and/or the bid interface information, which can be configured to cause, for example, the number of products remaining available to the group at the current group price to be displayed. Again, this may incentivize potential buyers to join the group and/or potential sellers to submit bids.

In step 832, some embodiments determine whether a received bid has been selected as an active bid, whether additional bids are received and/or whether one or more bids have a bid price that is greater than a current group price. Some embodiments include step 834 where the group build interface information and/or the bid interface information includes and/or is updated to include information that a group price has not been set when a bid has not been received for a group, one or more bids have conditions (e.g., seller minimum number) that have not been satisfied, or other such conditions exist such that a bid has not been selected as an active bid and a group price has yet to be specified. Accordingly, the group build interface information and/or the bid interface information may be configured to cause an “Awaiting Bids” notification to be displayed to members of the group, potential buyers, and/or potential sellers.

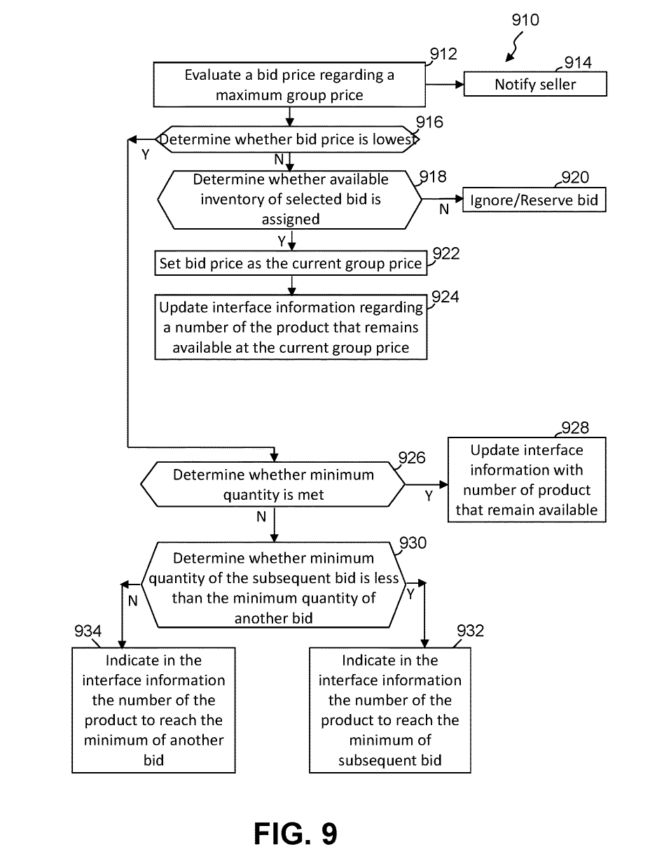

Some or all of the process may be implemented through one or more of the group generation servers, while in some embodiments at least some of the process 810 is implemented through buyer devices and/or seller devices in communication with the group generation servers. Further, some embodiments implement the process 810 for each seller bid and/or each request from a potential buyer to join a group. In some embodiments, some or all of the process 810 may be repeated one or more times while a group is open. Still further, in some embodiments, the process 810 initiates a subsequent process 910 of FIG. 9, and/or provides information utilized in implementing the process 910.

FIG. 9 shows a simplified flow diagram of an exemplary process 910 of maintaining group build interface information and bid interface information, and providing access to the group build interface information and the bid interface information. Typically, the process 910 is implemented after at least a bid (e.g., a first bid) has been selected as an active bid and a bid price of the first bid set as the group price. In step 912, a subsequent bid (e.g., a second bid) is evaluated to determine whether the second bid price of the second bid is below the maximum group purchase price corresponding to the group for which the second bid was submitted. Some embodiments include step 914 where the potential seller that submitted the second bid is notified that the bid price is above the maximum group purchase price in response to determining that second bid prices is greater than the maximum group purchase price. The notification can be through one or more web pages, the disbursement of updated bid interface information, through an email, text message and/or other such methods of notification. For example, bid interface information may be updated to cause a notice to be displayed through a bid user interface displayed in accordance with the updated bid interface information. In some implementations, the second bid is ignored and/or discarded when the second bid price is greater than the maximum bid purchase price. Additionally, in some instances, the group build interface information and/or the bid interface information may specify and/or be updated to specify that the group is awaiting additional bids. Further, the group build interface information and/or the bid interface information can be configured to cause user interfaces to display to potential buyers and/or sellers that the system continues to wait for bids to be submitted and/or requests further bids.

In step 916, the second bid is further evaluated to determine whether the second bid price of the second bid is less than an existing group price and/or less than bid prices of one or more previously received bids corresponding to the product group. In some embodiments, the determination of whether the second bid price is the lowest bid price is further conditioned on whether the number of product agreed to be purchased by the members of the group is equal to or exceeds a seller specified minimum number included in the second bid. Similarly, a comparison to other bid prices may be restricted to only those bids that also have a seller specified minimum number that are less than or equal to the number of products agreed to be purchased by the group at the time a current lowest bid price is being identified. When the second bid price is not the lowest price and/or is not less than the currently set group price, the subsequent bid is not selected as the current bid to satisfy the group.

In step 918, some embodiments determine whether the available inventory (e.g., the seller maximum number) of the product that a selected bid (e.g., a first bid) has agreed to sell are all assigned to be sold to members of the group. In those instances where a seller specified maximum number of products have not been requested by the group, step 920 is entered and the second bid is ignored. In other implementations, the second bid may be reserved in an event that should the number of products requested by the product group increase to exceed the seller maximum number specified in the active or selected bid.

In step 922, when the available inventory of the product that the selected bid has agreed to sell are assigned, the second bid may be selected (e.g., when the second bid price is the lowest of the remaining bids and/or has a seller specified minimum number that is less than the remaining number of products not satisfied by the first bid) and the second bid price may be set as an active group price for one or more products in excess of the assigned inventory. In step 924, the group build interface information and/or the bid interface information may be updated to specify the bid price of the second bid as the group price for products requested by the group that could not be fulfilled by the first bid. Similarly, the updated group build interface information and/or the bid interface information may cause a user interface displayed to the potential sellers and/or buyers to display the second bid price as the group price and/or the number of products remaining at the second bid price (i.e., the number of products remaining until a seller maximum number of the second bid is reached).

When it is determined in step 916 that the second bid price of the second bid is the lowest bid price, some embodiments continue to step 926 to determine whether the number of products requested to be purchased by the group is equal to or greater than the seller specified minimum number or quantity of the product as identified in the second bid. In step 928, the group build interface information and/or the bid interface information may be updated and/or modified, in response to confirming that the quantity of the product agreed to be purchased by the members of the product group is equal to or exceeds the second bid's seller specified minimum, to identify a current group price equal to the second bid price. Some embodiments further modify the group build interface information and/or the bid interface information to indicate a number of the product that remain available at the current group price based on the second bid's seller specified maximum number. Still further, in some instances, the group build interface information and/or the bid interface information may be configured to cause the number of the product that remains available at the current group price, based on the seller maximum number specified in the second bid, be displayed to potential buyers and/or potential sellers.

When it is determined in step 926 that the seller specified minimum number of the second bid is not met, some embodiments include step 930 to determine whether a seller specified minimum number of the second bid is less than a seller specified minimum number of one or more other bids having a bid price that is greater than the second bid price of the second bid. When the seller specified minimum number of the second bid is less than the seller specified minimum number of the one or more other bids, some embodiments include step 932 where the second bid may be held as a reserved bid or incentivizing bid, and the group build interface information and/or the bid interface information is updated and/or may be configured to cause an additional number of the product that must be requested to be purchased through the group in order to reach the seller specified minimum number of the second bid, and thus set the group price equal to the lower second bid price of the second bid. Again, this may incentivize potential buyers to join the group knowing that a further reduced price will only have to be paid if the group reaches the second bid's seller specified minimum number. Alternatively, in step 934 the group build interface information and/or the bid interface information is updated and/or may be configured to cause information to be displayed to potential buyers and/or sellers regarding an additional number of products that must still be requested to be purchased through the group in order to reach the seller specified minimum number of another bid, and thus a bid price of the other bid. As with the other processes described herein, some or all of the steps of the process 910 can be repeated. For example, some or all of the steps may be repeated for each bid received.

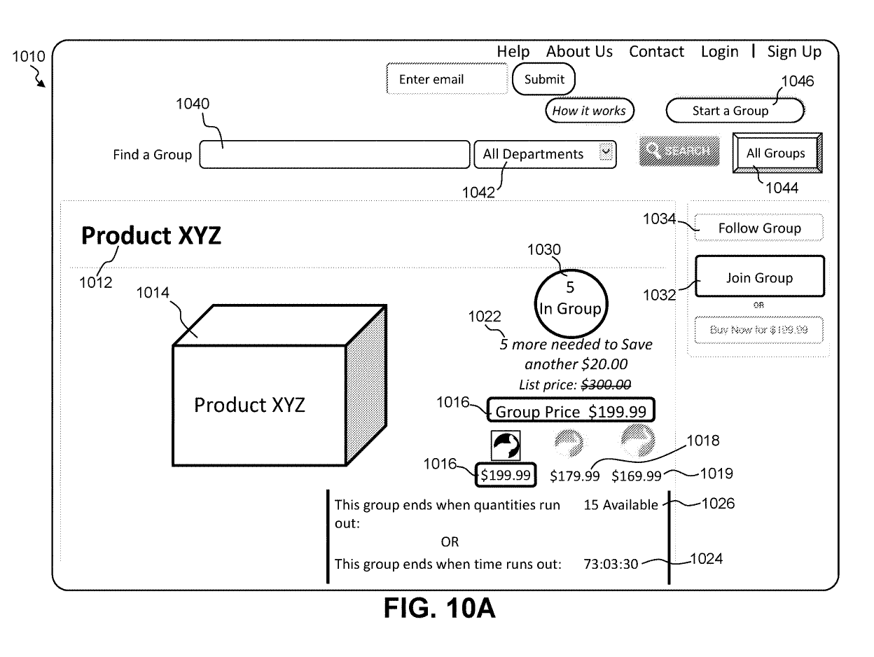

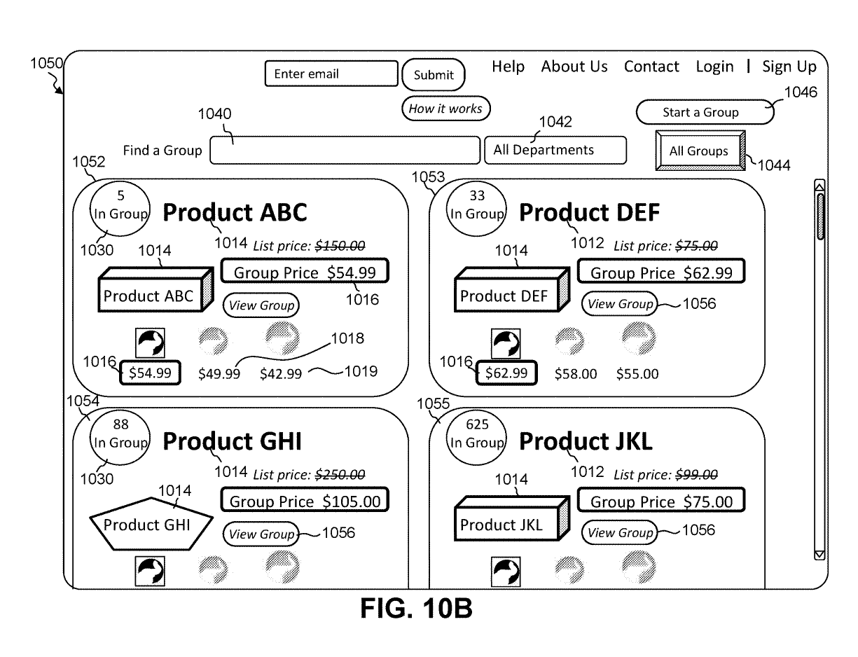

FIG. 10A shows a simplified block diagram of an exemplary displayed product group user interface 1010, in accordance with some embodiments, which is configured to display through buyer and/or seller devices accessing, via the distributed network 214, the group generation service 210. As described above, the group generation and/or build service 210 maintains and updates group build interface information. This information can be used to generate user interfaces (e.g., through one or more web pages) that can be distributed to potential buyers and/or sellers to be displayed. In other implementations, some or all of the group build interface information is distributed to one or more potential buyer devices 216 and/or seller devices 218, and is configured to populate some or all of the product group user interface 1010 and/or cause the product group user interface 1010 to be displayed.

Typically, the product group user interface includes product identifying information 1012 that allows a user to identify a product, for example, through product name and other relevant product information that allows a potential buyer (and/or seller) to accurately identify the product being offered through the product group associated with this product (for example, but not limited to product name, manufacturer, distributor, contents, quantities, size, weight, etc.). Further, some implementations include one or more product images 1014, drawings or the like of the product, which may include further identifying information (e.g., product name, manufacturer, distributor, contents, quantities, size, weight, etc.). Typically, when a seller bid has been selected, the displayed product group user interface 1010 identifies an active or current group price 1016. Further, some embodiments identify one or more other seller bid prices 1018, 1019 corresponding to one or more non-selected and/or reserved seller bids that typically have a group price less than that of the currently selected bid price while having seller specified minimum numbers or quantities that have not yet been reached by the group. In some implementations graphics may be provided representative of a size of a group corresponding to pending seller bids. Further, some embodiments identify the number of additional products 1022 that have to be agreed to be purchased by the members of the product group before the reduced bid price is selected as the active group price (e.g., “5 more needed to Save another $20.00) and/or the potential group price if the number of products requested by the product group and/or the group size reaches the seller minimum number. Again, the display of the one or more other bid prices and corresponding group size needed to satisfy that bid may incentivize potential buyers to join the group to get the savings. Further, the members of the group know that do not have to pay more than the current group price 1016, but may eventually pay less than current group price if the number of products requested by the group reaches an alternative seller minimum number.

Some embodiments identify an amount of time remaining 1024 before the group closes. Similarly, some embodiments specify a remaining number of products 1026 of the seller maximum number of the product that remain available at the current group price 1016. In some embodiments, the product group user interface 1010 may further identify a current number of products agreed to be purchased 1030 through the product group.

A join option 1032 is further included in the product group user interface 1010 to allow a potential buyer to join the group by agreeing to purchase at least one of the products and pay at most the specified current group price 1016 at the time the buyer joins the group, and potentially pay less if sufficient numbers of products are agreed to be purchased and/or the group size achieves threshold limits (e.g., reaches a seller specified minimum number of another bid that has a lower bid price than the current group price 1016. Some embodiments may include a group follow option 1034 that allows a potential buyer to track the progress of the group (e.g., track changes in the group price, number of product remaining 1026 at a group price, amount of time remaining 1024 that the group is to continue to be open, and/or other such information).

Further, in some embodiments, the group user interface 1010 may include a search option 1040 and/or field that allows a user to search for a group and/or product that a potential buyer is interested in purchasing. It is noted that in some instances, a product identification 1012 and/or product image 1014 may not be initially displayed until a potential buyer and/or seller initiate a search and identify and/or select a group identified from the search. In some instances, the search may be refined through the selection of one or more filters 1042, such as different departments, types of product (e.g., electronics, luggage, exercise equipment, outdoor/camping equipment, etc.), size, color, and/or other such filtering. Further, some embodiments allow a combination of different filtering to be applied. An all groups option 1044 (or a subset of all of the groups option(s)) may also be provided in some embodiments that can cause a display of some or all the potential groups that a potentially buyer may join and/or for which a potential seller may submit bids. This can allow a potential buyer and/or seller to scroll through potential groups looking for one or more products of interest. In some embodiments, the group user interface 1010 may also include a group start option 1046 that allows a potential buyer to identify a product the buyer wants to purchase and to potentially activate a group exclusively associated with the specified product. Other options and/or controls may be provided, such as but not limited to a help option, information options, contact options, user login option, sign-up option, and/or other such options.

FIG. 10B shows a simplified block diagram of an exemplary displayed product group user interface 1050, in accordance with some embodiments, which is configured to display through a potential buyer device accessing, via the distributed network 214, the group generation service 210. The group user interface 1050 displays multiple different product group or product group summaries 1052-1055 that can be viewed. A scroll bar or other such functionality may be provided when the number of product group summaries extend beyond a current view. Accordingly, substantially any number of product group summaries may be displayed. Further, in some embodiments, each of the different product group summaries includes a view group option 1056 that allows the potential buyer and/or seller to view more details about the product group and/or the product exclusively associated with the respective group. The product group user interface 1050 may be displayed, in some embodiments, upon initially accessing the group generation service, in response to a search and/or other such instances.

Some embodiments are configured to cause a similar seller bid user interfaces utilizing the bid interface information. Accordingly, a seller can search for one or more products the seller wants to consider for submitting a bid. Further, in some embodiments, the seller bid user interface may include an option to allow a seller to initiate a group while submitting a bid corresponding to the group.

Again, the group generation service is established through a cooperative network of computational servers distributed over the distributed network 214 and accessible by hundreds of thousands of potential buyers over the distributed network. Potentially buyers can start, search and/or view potential groups, and decide whether to join a group to purchase a product exclusively associated with the joined group. Similarly, the group generation service provides thousands of potential sellers or more with access over the distributed network to group bid interface information. The group bid interface information is configured to allow one or more potential sellers to submit, through a seller consumer electronic (CE) device, a seller bid to be a product source to fulfill at least a portion of the sales of the product exclusively associated with a product group to members of the product group. In some embodiments, each seller bid comprises a seller specified minimum number of the product at a seller bid price that members of the product group are to pay in purchasing the product should a number of the product agreed to be purchased by the plurality of buyers that join the group equal or exceed the seller specified minimum number of the product.

Typically, bids from sellers are received specifying a seller bid price at which the seller is willing to sell the first product to members of the product group. In some embodiments, the seller is associated with product group. As described above the first seller bid price can be designated as the group price that the members of the first group are to pay to purchase the first product at least when the seller bid price is less than the maximum group price. Further, the seller bid typically includes a seller specified minimum number of the first product specifying a minimum number of the first product that members of the first group must agree to purchase before the seller bid price can be designated as the group price. In some embodiments, the seller bid prices is designated as the group price when the seller bid prices is the lowest bid price of bids that the seller specified minimum number that is less than the number of products that have been requested by the group and/or a number of the product requested to be purchased by the members of the group is equal to or exceeds the seller specified minimum number.

Additionally, in some instances, a group price is changed or replaced by a subsequently received bid price. For example, a seller bid can be received that specifying a seller bid price at which the seller agrees to sell the product to members of the product group. A previous group price corresponding to a different seller can be replaced with the subsequent seller bid price when the subsequent seller bid prices is less than the maximum group price and is lower than the previous group price. Some embodiments determine whether one or more additional restrictions and/or criteria are met before changing the group price to the subsequent bid price. For example, some embodiments do not change the group price until the group agrees to purchase at least a minimum number of the product corresponding to the seller specified minimum number; the group generation service may further consider other fees and/or costs not specified in a seller bid price; and/or other such criteria.

In completing a sale, some embodiments confirm that the number of the product requested to be purchased through the group is equal to or exceed the seller specified minimum number of the product. A sale of the product by the seller to each of the plurality of buyers of the product group is initiated when the number of the product requested to be purchased through the product group is equal to or exceed the seller specified minimum number of the first product. Some embodiments initiate a charge, to each of the plurality of buyers of the product group, of the group price corresponding to the bid price of the active or selected bid for each of the product that each respective buyer agreed to purchase. The initiation of the sale may occur in response to a time threshold that results in a closing of the group, a number of products reaching a seller specified maximum number and/or other such reasons. For example, a received seller bid typically comprises a seller specified maximum number of the first product that the seller agrees to sell to the members of the product group at the specified seller bid price. The group can be maintained as open and the group generation service can continue to join additional buyers to the product group while the number of the product requested to be purchased by the members of the product group is below the seller specified maximum number. Some embodiments close the product group such that other buyers cannot join the product group to purchase the product at the seller bid price when the number the first product requested to be purchased by the members of the first group is equal to or exceeds the seller specified maximum number.

As described above, the group generation service 210 is typically implemented through one or more services and/or circuitry distributed over the network 214. In some embodiments, the group generation service comprises multiple servers that are communicationally coupled to coordinate the operation of the service. Some embodiments further include circuitry configured to implement at least some of the processing and/or processes in providing the group generation service. For example, some embodiments include the group build interface circuitry that maintains, updates and/or distributes interface information to the potential buyers and/or sellers, and in some instances may include buyer interface circuitry and seller interface circuitry. Further, in some embodiments, the group build interface circuitry includes one or more processors cooperatively operating and accessing memory to obtain and store information of the group build interface information and/or bid interface information. Typically, the processors access and/or maintain one or more databases comprising processor and/or computer readable memory that store the relevant interface information.

Some embodiments comprise group pricing circuitry configured to evaluate bid prices, corresponding seller specified minimum and maximum numbers of products, maximum group purchase price and/or other such information in selecting and/or updating a current group price. In some implementations, the group pricing circuitry is implemented through one or more computers, processors, databases, other memory or combinations thereof, which may be in one location or distributed over a distributed network, such as a local area network (LAN), a wide area network (WAN), the Internet, other such network or combination of such networks. For example, the group pricing circuitry can comprise one or more processors having access to processor readable and/or computer readable memory storing programming, code, firmware, executables, data, information or the like, or combinations thereof. Further, in some embodiments, the group pricing circuitry can be implemented as a stand-alone system in communication with one or more group generation servers 212 and/or implemented on one or more group generation servers.

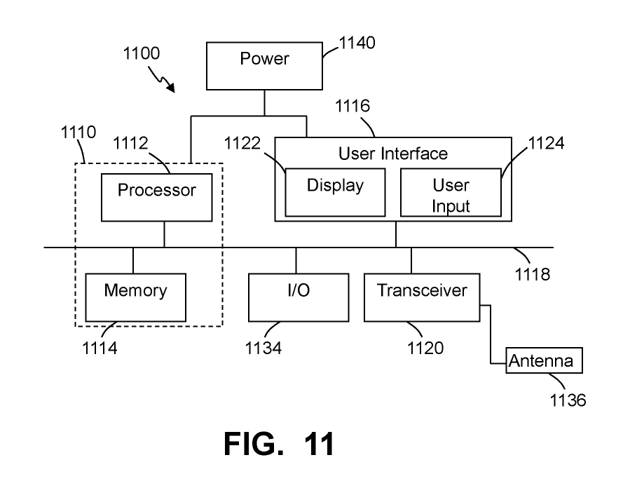

The methods, techniques, systems, circuitry, devices, services, servers, sources and the like described herein may be utilized, implemented and/or run on many different types of devices and/or systems. Referring to FIG. 11, there is illustrated exemplary circuitry and/or a system 1100 that may be used for any such implementations, in accordance with some embodiments. One or more components of the system 1100 may be used for implementing any system, circuitry, apparatus or device mentioned above or below, or parts of such systems, circuitry, apparatuses or devices, such as for example any of the above or below mentioned exemplary group generation service 210, group generation servers 212, master server 211, buyer devices, seller devices, manufacturer and/or distributor devices, group build interface circuitry, information collection circuitry, seller bid interface circuitry, registration circuitry, buyer profile circuitry, seller profile circuitry, group pricing circuitry and the like. However, the use of the system 1100 or any portion thereof is certainly not required.

By way of example, the system 1100 may comprise a controller or processor module 1112, memory 1114, a user interface 1116, and one or more communication links, paths, buses or the like 1118. A power source or supply 1140 is included or coupled with the system 1100. The controller 1112 can be implemented through one or more processors, microprocessors, central processing unit, logic, local digital storage, firmware and/or other control hardware and/or software, and may be used to execute or assist in executing the steps of the processes, methods and techniques described herein, and control various communications, programs, content, listings, services, interfaces, etc. Further, in some embodiments, the controller 1112 can be part of a control system 1110 and/or implemented through one or more processors with access to one or more memory 1114. The user interface 1116 can allow a user to interact with the system 1100 and receive information through the system. In some instances, the user interface 1116 includes a display 1122 and/or one or more user inputs 1124, such as a keyboard, mouse, track ball, remote control, buttons, touch screen, etc., which can be part of or wired or wirelessly coupled with the system 1100.

Typically, the system 1100 further includes one or more communication interfaces, ports, transceivers 1120 and the like allowing the system 1100 to communication over a communication bus, a distributed network, a local network, the Internet, communication link 1118, other networks or communication channels with other devices and/or other such communications or combinations thereof. Further the transceiver 1120 can be configured for wired, wireless, optical, fiber optical cable or other such communication configurations or combinations of such communications.

The system 1100 comprises an example of a control and/or processor-based system with the controller 1112. Again, the controller 1112 can be implemented through one or more processors, controllers, central processing units, logic, software and the like. Further, in some implementations the controller 1112 may provide multiprocessor functionality. Still further, in some instances, the controller may be implemented through multiple controllers and/or processors distributed over a network (e.g., LAN, WAN, Internet, etc.).

The memory 1114, which can be accessed by the controller 1112, typically includes one or more processor readable and/or computer readable media accessed by at least the controller 1112, and can include volatile and/or nonvolatile media, such as RAM, ROM, EEPROM, flash memory and/or other memory technology. Further, the memory 1114 is shown as internal to the system 1110; however, the memory 1114 can be internal, external or a combination of internal and external memory. Similarly, some or all of the memory 1114 can be internal, external or a combination of internal and external memory of the controller 1112. The external memory can be substantially any relevant memory such as, but not limited to, one or more of flash memory secure digital (SD) card, universal serial bus (USB) stick or drive, other memory cards, hard drive and other such memory or combinations of such memory. Additionally, in some instances, the memory may be implemented through multiple memory devices and/or databases distributed over a network (e.g., LAN, WAN, Internet, etc.). The memory 1114 can store code, software, executables, scripts, data, content, images, multimedia content, reference information, access information, profile information, programming, programs, textual content, identifiers, log or history data, user information and the like.

One or more of the embodiments, methods, processes, approaches, and/or techniques described above or below may be implemented in one or more computer programs executable by a processor-based system. By way of example, such a processor based system may comprise the processor based system 1100, a computer, laptop, tablet, smart phone, IP enabled television, etc. Such a computer program may be used for executing various steps and/or features of the above or below described methods, processes and/or techniques. That is, the computer program may be adapted to cause or configure a processor-based system to execute and achieve the functions described above or below. For example, such computer programs may be used for implementing any embodiment of the above or below described steps, processes or techniques for allowing potential buyers to join a group and establish a seller market incentivizing potential sellers to offer to be the supplier of a product to the group. As another example, such computer programs may be used for implementing any type of tool or similar utility that uses any one or more of the above or below described embodiments, methods, processes, approaches, and/or techniques. In some embodiments, program code modules, loops, subroutines, etc., within the computer program may be used for executing various steps and/or features of the above or below described methods, processes and/or techniques. In some embodiments, the computer program may be stored or embodied on a computer readable storage or recording medium or media, such as any of the computer readable storage or recording medium or media described herein.

Accordingly, some embodiments provide a processor or computer program product comprising a medium configured to embody a computer program for input to a processor or computer and a computer program embodied in the medium configured to cause the processor or computer to perform or execute steps comprising any one or more of the steps involved in any one or more of the embodiments, methods, processes, approaches, and/or techniques described herein. For example, some embodiments provide one or more computer-readable storage mediums storing one or more computer programs for use with a computer simulation, the one or more computer programs configured to cause a computer and/or processor based system to execute steps comprising: establishing, through a group generation service implemented through a cooperative network of computational servers distributed over a wide area distributed network, a first product group exclusively associated with a first product in response to a request from a first buyer; providing hundreds of thousands of potential buyers with access over the distributed network to group build interface information that allows potential buyers to communicate requests over the distributed network to join the first product group; receiving requests from over the distributed network from a plurality of buyers in accordance with the group build interface information each requesting to join the first product group and agreeing, along with each member of the first product group, to purchase at least one of the first product through the first product group; joining the plurality of buyers to the first product group in response to the requests; providing thousands of potential sellers with access over the distributed network to group bid interface information configured to allow potential sellers to communicate seller bids over the distributed network requesting to be selected as a seller of the product to the first product group; and receiving, from a plurality of potential sellers in accordance with the bid interface information, a plurality of different seller bids requesting to be selected as the seller for the first product group, wherein each seller bid of the plurality of different seller bids specifies a seller bid price at which the corresponding seller is willing to sell the first product to members of the first product group.

Other embodiments provide one or more computer-readable storage mediums storing one or more computer programs configured for use with a computer simulation, the one or more computer programs configured to cause a computer and/or processor based system to execute steps comprising: establishing a group generation service implemented through a cooperative network of computational servers distributed over a wide area distributed network and accessible by hundreds of thousands of potential buyers over the distributed network; receiving, at the group generation service and from over the distributed network, a request from a first buyer identifying a first product that the first buyer desires to purchase, wherein the first product is not available for purchase through the group generation service at the time the request from the first buyer is received and not associated with a plurality of existing groups that each correspond to a different product that members of the respective group are requesting to purchase; establishing a first product group exclusively associated with the first product in response to the request from the first buyer; obtaining researched product information comprising at least a cost to purchase the first product from one or more other potential product suppliers that are not associated with the group generation service with respect to the first product; determining a maximum group price for the first product based at least in part on the researched product information, wherein the maximum group price is less than a cost to purchase the first produce from one or more of the other potential product suppliers; determining a maximum group price for the first product based at least in part on an anticipated size of the first product group; allowing access, over the distributed network, to group build interface information that allows potential buyers to communicate requests over the distributed network to join the first product group; and joining a plurality of buyers to the first product group in response to requests received in accordance with the group build interface information from each of the plurality of buyers requesting to join the first product group and agreeing, along with each member of the first product group, to purchase at least one of the first product at a group price that is equal to or less than the maximum group price.

Still other embodiments provide one or more computer-readable storage mediums storing one or more computer programs configured for use with a computer simulation, the one or more computer programs configured to cause a computer and/or processor based system to execute steps comprising: establishing multiple different groups each exclusively associated with a different product requested by members of each of the multiple groups to be purchased by the members of the respective multiple groups; providing thousands of potential sellers with access, through a cooperative network of computational servers dispersed over a distributed network, to bid interface information, wherein the bid interface information identifies a first product exclusively corresponding to a first group of the multiple groups and exclusively established for the first product with each buyer of a plurality of different buyers that have joined the first group requesting to purchase the first product at a price that is not greater than a maximum group price, and the bid interface information is configured to allow one or more of the thousands of potential sellers to present a seller bid requesting to sell the first product to members of the first group; receiving, over the distributed network and in accordance with the bid interface information, a plurality of seller bids from two or more of the potential sellers, wherein each of the plurality of seller bids comprises a seller bid price specifying a price at which a corresponding seller is willing to sell the first product to one or more buyers of the first group; identifying that a first seller bid price specified in a first seller bid from a first seller of the plurality of seller bids is a lowest seller bid price and that at least a first seller specified minimum number of the first product is agreed to be purchased through the first group by the plurality of buyers of the first group; and setting the first seller bid price as a group price that the members of the first group are to pay to purchase the first product when the first seller bid price is less than the maximum group price, is a lowest bid price of all bid prices received from sellers requesting to supply the first product and that have seller specified minimum numbers of the first product that are equal to or less than a number of the first product agreed to purchase through the first group by the plurality of buyers of the first group.

Again, systems are provided that are configured to establish a competitive market for multiple different products. In some embodiments, such systems comprise the group generation service configured to establish and maintain multiple different product groups. Each product group expressly corresponds to a different product requesting to be purchased by members of each respective product group. In some instances, the group generation service comprises group build interface circuitry and group build circuitry. The group build interface circuitry is configured to maintain buyer interface information and allow access to the buyer interface information over a distributed network by hundreds of thousands of potential buyers, and further configured to receive information from requesting buyers regarding products requesting to be purchased.

The group build circuitry communicationally couples with the group build interface circuitry and, in some embodiments, is configured to receive, through the group build interface circuitry, a request from a first buyer identifying a first product that the first buyer desires to purchase. Typically, the first product is not available for purchase through the group generation service at the time the request from the first buyer is received. The group build circuitry can be configured to establish a first product group exclusively associated with the first product in response to the request from the first buyer.

In some embodiments, the group build circuitry comprises information collection circuitry and pricing circuitry. The information collection circuitry is typically configured to obtain researched product information including a cost to purchase the first product from one or more other potential product suppliers that are not associated with the group generation service with respect to the first product. The pricing circuitry is configured to determine a maximum group purchase price for the first product based at least in part on the researched product information. Again, the maximum group purchase price is typically less than a cost to purchase the first produce from one or more of the other potential product suppliers.

Further, in some embodiments, the group build circuitry is configured to instruct and/or direct the group build interface circuitry to allow access, by the hundreds of thousands of potential buyers over the distributed network, to group build interface information that allows potential buyers to communicate requests to join the first product group. In some instances, the group build circuitry is further joins to the first product group one or more buyers requesting to join the first product group and agreeing, along with each member of the first product group, to purchase at least one first product at a group price that is equal to or less than the maximum group purchase price.

In some embodiments, the group build interface circuitry further includes bid interface circuitry configured to maintain seller and/or bid interface information and allow access to the bid interface information over the distributed network by at least thousands of potential sellers. Further, the bid interface circuitry can be configured to receive information from potential sellers regarding pricing and number of the product a seller is willing to sell to the group. Some embodiments further comprise bid evaluation circuitry that receives some or all of the bid information received through a bid user interface maintained by the bid interface circuitry, and associated bids with product groups. Further, in some implementations, the bid evaluation circuitry identifies bids that are less than or equal to the maximum bid purchase price, have a seller specified minimum number that is equal to less than a number of products requested by the group, has a bid price that is less than one or more other bids, whether a bid price is a lowest bid price at least for bids that have seller specified minimum number that is equal to less than a number of products requested by the group, and/or other such evaluations, and typically a combination of these evaluations.

In some embodiments, buyer and/or group interface circuitry is provided that maintains the group interface information, receives and stores incoming potential buyer information, notifies and/or routes relevant information to other relevant circuitry and the like. Further, some embodiments include group initiation circuitry configured to initiate the plurality of groups based on buyer requests that groups be activated for particular products. In some instances, the group initiation circuitry includes product identification circuitry that is in communication with interface circuitry to receive product identifying information from the buyer requesting a group be activated. Further, the information collection circuitry can be separate from or part of the group initiation circuitry. In some embodiments, the information collection circuitry can be configured to confirm an accurate identification of the requested product and to acquire cost information for the product, where the accurate identification and/or the acquisition of cost information may include receiving some information from a researcher, employee or other person working with the group generation service and/or a third party service. Additionally or alternatively, some embodiments include price confirmation circuitry that confirms the validity of maximum group purchase prices, evaluates requesting buyer's specified pricing information, and/or confirm whether the buyer specified price is valid and/or should be set at the maximum group purchase price. Again, some information may be manually obtained and/or provided by a technician, employee or the like to the price confirmation circuitry and used in evaluating pricing. Typically, the price confirmation circuitry utilizes data from the information collection circuitry.

Some embodiments include, utilize and/or manage one or more databases that store product information, potential buyer information, potential seller information, and/or other such information. For example, some embodiments utilize and/or maintain one or more potential buyer databases, potentially seller databases, product group databases; product information databases; research databases; sales tracking databases that maintains information in tracking closed groups and whether members of the closed groups receive their product; or other such databases, and typically combinations of such databases. Typically, the databases are maintained through multiple computer readable memory spread over the distributed network 214. In some embodiments, however, one or more of the databases may be maintained in a single device and/or a collection of memory at a single location. Further, the one or more databases may be maintained on the one or more computational group generation servers 212.

Some embodiments cooperatively operate a network of group generation servers 212 distributed geographically over the distributed network 214 that is accessible to millions of computers and other consumer electronic devices, and that allows communication between the group generation servers of the network of group generation servers. In some implementations the group generation servers are implemented through one or more processor based systems configured to provide the functionality to simultaneously implement one or more group generation servers 212. Further, in some embodiments, the multiple group generation services operate cooperative and provide redundancy such at least two servers preform the same functionality. Still further, the group generation services typically cooperatively operation through communication between servers, and in some instances are cooperatively controlled. Group build interface information and/or bid interface information is distributed through the network of group generation servers to multiple remote potential buyer and/or seller devices accessing the distributed network that allow a user interface to be displayed allowing the multiple remote potential buyers and/or sellers to interact with the respective interfaces and communicate information to and receive information from the group generation servers.

Further, some embodiments provide methods of distributing products, comprising: establishing a group generation service implemented through a cooperative network of computational servers distributed over a wide area distributed network and accessible by hundreds of thousands of potential buyers over the distributed network; receiving, at the group generation service and from over the distributed network, a request from a first buyer identifying a first product that the first buyer desires to purchase, wherein the first product is unavailable for purchase through the group generation service at the time the request from the first buyer is received and unassociated with a plurality of existing groups that each correspond to a different respective product that members of the respective group are requesting to purchase; establishing a first product group exclusively associated with the first product in response to the request from the first buyer; obtaining researched product information comprising at least a cost to purchase the first product from one or more other potential product suppliers that are not associated with the group generation service with respect to the first product; establishing a maximum group price for the first product based at least in part on the researched product information, wherein the maximum group price is less than a cost to purchase the first produce from one or more of the other potential product suppliers; determining a maximum group price for the first product based at least in part on an anticipated size of the first product group; allowing access, over the distributed network, to group build interface information that allows potential buyers to communicate requests over the distributed network to join the first product group; and joining a plurality of buyers to the first product group in response to requests received in accordance with the group build interface information from each of the plurality of buyers requesting to join the first product group and agreeing, along with each member of the first product group, to purchase at least one of the first product at a group price that is equal to or less than the maximum group price.

Some embodiments receive a first seller bid specifying a seller specified maximum number of the first product that the first seller agrees to sell to the members of the first group at the first seller bid price. The first group can be maintained as open and continuing to join additional buyers to the first group while the number the first product requested to be purchased by the members of the first group is below the seller specified maximum number. Further, the first group can be closed such that other buyers cannot join the first group to purchase the first product at the first seller bid price when the number the first product requested to be purchased by the members of the first group is equal to or exceeds the seller specified maximum number.

Still further, some embodiments receive, from a first seller, a first seller bid specifying a first seller bid price that the first seller is willing to sell the first product to members of the first group. The first seller can be associated with the first group. In some instances, the first seller bid price is designated as a group price that the members of the first group are to pay to purchase the first product when the first seller bid price is less than the maximum group price.

In some embodiments, a seller bid is received comprises a seller specified minimum number of the first product specifying a minimum number of the first product that members of the first group must agree to be purchase before the first seller bid price can be designated as the group price. In some implementations, the first seller bid price can be designated as the group price when the first seller bid price is the lowest bid price and a number of the first product requested to be purchased by the members of the first group is equal to or exceed the seller specified minimum number of the first product. Additionally or alternatively, in some embodiments the first seller bid comprises a seller specified minimum number of the first product specifying a minimum number of the first product that members of the first group must agree to be purchase before the first seller bid price can be designated as the group price. Some embodiments further confirm that a number of the first product requested to be purchased through the first group is equal to or exceed the seller specified minimum number of the first product. A sale or sales can be initiated by the first seller to each of the first plurality of buyers of the first group when the number of products requested to be purchased through the first group is equal to or exceed the seller specified minimum number of the first product, and initiating to charge each of the plurality of buyers of the first group the first seller bid price for each of the first product that each respective buyer of the plurality of buyers of the first group agreed to purchase.

Some embodiments, in receiving the first seller bid, receive a seller specified maximum number of the first product specifying a maximum number of the first product that the first seller agrees to sell to the members of the first group at the first seller bid price. The first group can be maintained as open and continuing to join additional buyers to the first group while the number the first product requested to be purchased by the members of the first group is below the seller specified maximum number. Further, the first group can be closed such that other buyers cannot join the first group to purchase the first product at the first seller bid price when the number the first product requested to be purchased by the members of the first group is equal to or exceeds the seller specified maximum number.

In some embodiments, a first seller be can be received from a first seller with the first seller bid specifying a first seller bid price at which the first seller agrees to sell the first product to members of the first group. A previous group price that was bid by a different seller can be replaced with the first seller bid price and/or the group price can be modified to equal the first seller bid price when the first seller bid price is less than the maximum group price and is lower than the previous group price.

Some embodiments in establishing the first product group allow multiple potential buyers to be cooperatively joined together in establishing a mass of buyers and cooperatively establishing through the mass of buyers an enhanced market interest that incentivizes one or more sellers to sell the first product at a reduced cost due at least in part to a guaranteed number of sales of the first product to the members of the first group. Some embodiments further comprise: identifying that a number of the first product agreed to be purchased by the members of the first group has increased to at least equal the second seller minimum number; and setting the group price corresponding to the first group equal to the second seller bid price replacing the first seller bid price as the group price with the second seller bid price when the second seller bid price in response to the identifying that the number of the first product agreed to be purchased by the members of the first group has increased to at least equal the second seller minimum number. Additionally or alternatively, some embodiments further comprise identifying that a number of products requested to be purchased through the first group exceeds a first seller maximum number of the first product that the first seller bid to provide at the first seller bid price; identifying second seller bid; and initiating a sale of a number of the first product requested to be purchased through the first group that was in excess of the first seller maximum number through the second seller at a second seller bid price to fulfill a demand of the first product to the members of the first group that was in excess of the first seller maximum number.

Some embodiments establish a buyer's marketplace. This marketplace takes advantage of the strength in numbers of buyers and/or numbers or products agreed to be purchased. Further, the created marketplace for buyers leverages their buying power through group or larger numbered buying. Some embodiments additionally create a marketplace for sellers to at least expand their customer base, reduce inventory levels, and promote larger quantity purchases.

As described above, some embodiments allow sellers request to have groups created for products they wish to deeply discount. The group can become accessible to potential buyers through the group generation service. Further, in some instances, these seller based groups may be linked and visible on the potential sellers' website. Additionally or alternatively, sellers can promote a group, for example, by advertising the group on their web site, including a link on their web site, distributing information through customer and/or potential customer lists, etc. A prospective group may be created based on an assessment by the group generation service of whether the product is discounted appropriately based on the quantity purchased and/or based on a quantity predicted to be purchased. In some implementations, the group generation service may negotiate (e.g., through employees of the group generation service and/or third party entity working with the group generation service) with sellers, manufacturers, dealers, distributors, etc. for quantity discounts. The prospective group can be opened with discount thresholds and/or maximum group purchase price posted for potential buyers to access and view. Buyers are joined to the group in response to requests from the buyers. Further, the group generation service provides access to a search engine to search for products and/or groups that a potential buyer and/or seller may be interested in. Typically, the group remains open for at least a threshold time period. Some embodiments determine the threshold time period and/or the threshold time period may vary, for example, based on the product associated with the group, number of potential buyers viewing the group information, number of products requested to be purchased over time, the number of the product predicted to be sold through the group, requests by the seller and/or other such factors. In some embodiments, while the group remains open, the group generation service may actively negotiate with one or more potential sellers to submit bids and fulfill the request from the group. When the group is closed, the members of the group get to buy the product at the greatest offered discount for the number of products available. The group generation service, in some embodiments, focuses on consolidating buys for deeper discounts. Further, the group generation service can take advantage of and/or increase reliance on social networking and social gaming to, at least in part, promote groups and increasing group sizes.

Again, in some embodiments, the group generation service may allow one or more sellers to create seller initiated and/or pre-manufacture groups. The pre-manufacture group can allow manufacturers to plan larger production runs with the confidence that sufficient number and/or all units of the product are already sold. In some instances, such pre-manufacture groups may remain open for a longer period of time. The group may be close when a time period expires and/or a production maximum and/or minimum is met. Typically, the group will close unsuccessfully when the production minimum is not met and the seller is not required to sell the product to the members that joined the group.

In some implementations, the group generation service may be configured to accept group member payments and/or issue purchase orders to sellers. The sellers are typically responsible for fulfillment of the orders. In some instances, however, the group generation service may distribute the products to members of groups and/or authorize distribution from one or more warehouses. For example, quantities of the product may be distributed to multiple different warehouses that are geographically distributed. Upon closing of a group, the group generation service may instruct the distribution of one or more products from warehouses that are close to respective individual members of the group. Similarly, in some embodiments, the group generation service may accept bulk shipment of a product. The group generation can then distribute the products to provide individual fulfillment. Further, in some embodiments the group generation service evaluates and/or polices sellers to ensure they are complying with the agreed sale, providing the accurate product and/or other such evaluation of seller performance. Typically, returns of the product, if allowed, are handled by the seller.

Still further, in some embodiments, the group generation service obtains a fee from the seller. This fee may be a flat rate, may be based on numbers of products sold, percentage of total sales price, and/or other such arrangements. In some instances, the amount the group generation service receives may be negotiated with potential sellers and/or may be discounted for larger groups, numbers or different groups a seller is satisfying, number of bids received from a seller, number of times a sellers is selected as a group price and/or other such factors. For example, for groups generated in response to a seller request, the group generation service may receive one of a range of percentage of the sale price (e.g., 0.5%-25% of the sale price), and may depend on many factors, such as those described above. Similarly, the group generation service may receive a percentage of a discount savings obtained below a competitive seller price and/or below a maximum group purchase price. Still further, in some embodiments, the group generation service may obtain payment based on advertising space.

Accordingly, some embodiments establish buyer driven group-buying demand. Methods and/or systems are provided that enable buyers to establish and consolidate demand for a product, which may be through an on-line group-buying environment. Buyers identify a product in which they want to consolidate demand in order to receive a more competitive bid. Other buyers identify their demand for the same product. The system establishes a maximum bid price for the product. Buyers agree to participate in a consolidated group-buy based on this maximum sale price. Sellers are provided information, interface and/or a system where they can bid for the buyers' demand. Some implementations provide seller or vendor bidding for buyer driven group-buying demands. Again, method and/or system are provided that enable sellers to bid on consolidated buyer demand for a product of a group through the group generation service (e.g., accessible over the distributed network of an on-line group-buying sale). Sellers are allowed to bid based on the current and/or predicted product demand from the group buy. Further, in some embodiments, the sellers may be allowed to automatically de-escalate their bid based on the total product demand from the group buy or based on another seller's bid. The system, in some implementations, provides real time feedback to sellers and/or buyers, such as numbers of members of a group, numbers of products agreed to be purchased, on whether the seller's bid is the lowest bid or not, whether minimum and/or maximum thresholds are met, whether a group closed, whether a group closed successfully or unsuccessfully and/or other such feedback.

Some embodiments further implement a loyalty rewards program for the group buying. Buyers and/or sellers may be able to earn loyalty points which entitle them to a portion of the profit from a group-buying sale, provide access to limited access groups, provide additional discounts on subsequent groups, and/or other such rewards and/or incentives. The profit sharing may be available immediately in the form of a discount from the final price of the product purchased, may be differed (e.g., based on group generation service discretion, buyer discretion, seller discretion, or a combination thereof).

As described above, some embodiments take advantage of social networking and/or social gaming for group buying. Accordingly, some embodiments track and provide leader board results for buyers who initiate the group-buying activity. Additionally or alternatively, loyalty rewards in the form of discounts and products may be highlighted, made public and/or provided to potential buyers and/or sellers. For example, loyalty rewards in the form of discounts and products may be provided to the buyers who consolidate the most demand for a single product, consolidate the largest number of groups, etc. As also described above, some embodiments allow for seller initiated group creation and/or buying. This allows sellers to consolidate demand for a product. For example, sellers can establish price de-escalation values based on the size of the group or total demand for the product.

Exemplary processes and/or methods are representatively described above based on one or more flow diagrams, timing diagrams and/or diagrams representing sequences of actions and/or communications that include one or more steps, subprocesses, communications and/or other such representative divisions of the processes, methods, etc. These steps, subprocesses or other such actions can be performed in different sequences without departing from the spirit of the processes, methods and apparatuses. Additionally or alternatively, one or more steps, subprocesses, actions, etc. can be added, removed or combined, and/or steps from different processes or subprocesses can be cooperated to define a process in some implementations.

While the invention herein disclosed has been described by means of specific embodiments, examples and applications thereof, numerous modifications and variations could be made thereto by those skilled in the art without departing from the scope of the invention set forth in the claims.

What is claimed is:

1. A method of distributing products, comprising:
establishing, through a group generation service implemented through a cooperative network of computational servers distributed over a wide area distributed network, a first product group exclusively associated with a first product in response to a request from a first buyer;
providing hundreds of thousands of potential buyers with access over the distributed network to group build interface information that allows potential buyers to communicate requests over the distributed network to join the first product group;
receiving requests from over the distributed network from a plurality of buyers in accordance with the group build interface information each requesting to join the first product group and agreeing, along with each member of the first product group, to purchase at least one of the first product through the first product group;
joining the plurality of buyers to the first product group in response to the requests;
providing thousands of potential sellers with access over the distributed network to group bid interface information configured to allow potential sellers to communicate seller bids over the distributed network requesting to be selected as a seller of the product to the first product group; and
receiving, from a plurality of potential sellers in accordance with the bid interface information, a plurality of different seller bids requesting to be selected as the seller for the first product group, wherein each seller bid of the plurality of different seller bids specifies a seller bid price at which the corresponding seller is willing to sell the first product to members of the first product group.

2. The method of claim 1, further comprising:
evaluating the multiple different seller bids;
selecting a first seller bid as a function of the seller bid price specified in the first seller bid received from a first seller as a function of the evaluation; and
designating the first seller bid price as a group price that the members of the first product group are to pay to purchase the first product.

3. The method of claim 2, wherein the evaluating the multiple different seller bids comprises confirming the first seller bid price is less than a maximum group purchase price specified by the group generation service; and
wherein the designating the first seller bid price comprises designating the first seller bid price as the function of the seller bid price and when the first seller bid price is less than a maximum group purchase price.

4. The method of claim 2, further comprising:
modifying, in response to the designating the first seller bid price as the group price, the group build interface information corresponding to the first product group specifying the first seller bid price as the group price;
distributing, over the distributed network, at least a portion of the group build interface information configured to cause, upon potential buyers accessing relevant information corresponding to the first product group, the first bid price to be displayed as a maximum price the potential buyers would agree to pay to purchase the first product should the potential buyer join the first group.

5. The method of claim 2, wherein the evaluating the multiple different seller bids comprises confirming that a seller specified minimum number of the first product specified in the first seller bid is less than a number of the first product the members of the first group have agreed to purchase.

6. The method of claim 2, further comprising:
confirming that a number of the first product requested to be purchased through the first group is equal to or exceed a seller specified minimum number of the first product designated in the first seller bid; and
initiating a sale of the first product by the first seller to each of the members of the first group when the number of products requested to be purchased through the first group is equal to or exceed the seller specified minimum number of the first product, and initiating to charge each of the plurality of buyers of the first group the first seller bid price for each of the first product that each respective buyer of the plurality of buyers of the first group agreed to purchase.

7. The method of claim 2, further comprising:
receiving, from a second seller, a second seller bid specifying a second seller bid price and a second seller specified minimum number;
identifying that the second seller bid price is a lower bid price than the first seller bid price;
identifying that the number of the product agreed to be purchased by the members of the first product group is less than the second seller specified minimum number; and
holding the second seller bid in reserve, in response to the identifying that the number of the product agreed to be purchased by the members of the first product group is less than the second seller specified minimum number, such that the second seller bid is available to be selected as the group bid should the number of the product agreed to be purchased by the members of the first product group increase to at least equal the second seller specified minimum number.

8. The method of claim 1, further comprising:
obtaining researched product information comprising at least a cost to purchase the first product from one or more other potential product suppliers that are not associated with the group generation service with respect to the first product; and
establishing a maximum group purchase price for the first product based at least in part on the researched product information, wherein the maximum group price is less than a cost to purchase the first produce from one or more of the other potential product suppliers and defines a limit that bid prices of each of the plurality of seller bids is to be less than to be consider as a valid bid.

9. The method of claim 1, further comprising:
receiving, at the group generation service and from over the distributed network, a request from a first potential buyer identifying the first product that the first buyer desires to purchase, wherein the first product is unavailable for purchase through the group generation service at the time the request from the first buyer is received and unassociated with a plurality of existing groups that each correspond to a different respective product that members of the respective group are requesting to purchase; and
establishing the first product group exclusively associated with the first product in response to receiving the request from the first potential buyer.

10. The method of claim 1, further comprising:
receiving one or more additional requests from one or more additional buyers requesting to join the first group and agreeing to purchase the first product at the first group price that is not greater than a maximum group purchase price;
modifying the group build interface information, in response to join in the one or more additional buyers to the first group, to provide notification of a quantity of first product the first group as agreed to purchase.

11. The method of claim 1, wherein the receiving the plurality of different seller bids comprises receiving, from a subsequent seller, a subsequent seller bid specifying a subsequent seller bid price at which the subsequent seller agrees to sell the first product to members of the first product group; and
changing the first group price to the subsequent seller bid price when the subsequent seller bid price is lower than the first group price.

12. The method of claim 1, wherein the establishing the first product group comprises allowing multiple potential buyers to be cooperatively joined together in establishing a mass of buyers and cooperatively establishing through the mass of buyers an enhanced market interest that incentivizes one or more sellers to sell the first product at a reduced cost due at least in part to a guaranteed number of sales of the first product to the members of the first group.

13. A method of distributing products, comprising:
establishing a group generation service implemented through a cooperative network of computational servers distributed over a wide area distributed network and accessible by hundreds of thousands of potential buyers over the distributed network;
establishing, through the group generation service, a first product group exclusively associated with a first product in response to a request from a first buyer;
allowing access, over the distributed network, to group build interface information that allows potential buyers to communicate requests over the distributed network to join the first product group; and
joining a plurality of buyers to the first product group in response to requests received in accordance with the group build interface information from each of the plurality of buyers requesting to join the first product group and agreeing, along with each member of the first product group, to purchase at least one of the first product at a group price.

14. The method of claim 13, further comprising:
providing access, by thousands of potential sellers and over the distributed network, to group bid interface information, wherein the group bid interface information is configured to allow one or more potential sellers to submit, through seller consumer electronic (CE) devices, a seller bid to be a product source to fulfill at least a portion of sales of the first product to members of the first group, wherein each seller bid comprises a seller specified minimum number of the first product at a seller bid price that members of the first group are to pay in purchasing the first product should a number of the first product agreed to be purchased by the plurality of buyers that join the first group equal or exceed the seller specified minimum number of the first product.

15. The method of claim 13, further comprising:
receiving one or more additional requests from the plurality of buyers requesting to join the first group and agreeing to purchase the first product at the price that is not greater than the maximum group price; and
joining each of the multiple different buyers to the first group by associating an identifier of each of the multiple different buyers with the first group.

16. The method of claim 13, further comprising:
receiving a first seller bid comprising a seller specified minimum number of the first product specifying a minimum number of the first product that members of the first group must agree to purchase before the first seller bid price can be designated as the group price; and
designating the first seller bid price as the group price when the first seller bid price is the lowest bid price and a number of the first product requested to be purchased by the members of the first group is equal to or exceed the seller specified minimum number of the first product and the first seller bid price is the lowest bid price of bids received having a seller specified minimum number less than or equal to the number of the product agreed to be purchased by the first group.

17. A method of establishing a competitive seller market, comprising:
establishing multiple different groups each exclusively associated with a different product requested by members of each of the multiple groups to be purchased by the members of the respective multiple groups;
providing thousands of potential sellers with access, through a cooperative network of computational servers dispersed over a distributed network, to bid interface information, wherein the bid interface information identifies a first product exclusively corresponding to a first group of the multiple groups and exclusively established for the first product with each buyer of a plurality of different buyers that have joined the first group requesting to purchase the first product at a price that is not greater than a maximum group price, and the bid interface information is configured to allow one or more of the thousands of potential sellers to present a seller bid requesting to sell the first product to members of the first group;
receiving, over the distributed network and in accordance with the bid interface information, a plurality of seller bids from two or more of the potential sellers, wherein each of the plurality of seller bids comprises a seller bid price specifying a price at which a corresponding seller is willing to sell the first product to one or more buyers of the first group;
identifying that a first seller bid price specified in a first seller bid from a first seller of the plurality of seller bids is a lowest seller bid price and that at least a first seller specified minimum number of the first product is agreed to be purchased through the first group by the plurality of buyers of the first group; and
setting the first seller bid price as a group price that the members of the first group are to pay to purchase the first product when the first seller bid price is less than the maximum group price, is a lowest bid price of all bid prices received from sellers requesting to supply the first product and that have seller specified minimum numbers of the first product that are equal to or less than a number of the first product agreed to purchase through the first group by the plurality of buyers of the first group.

18. The method of claim 17, further comprising:
receiving, from a second seller, a second seller bid after the first seller bid price is set as the group price, wherein the second seller bid specifies a second seller bid price that the second seller is willing to sell the first product to the members of the first group; and
setting the group price equal to the second seller bid price replacing the first seller bid price as the group price with the second seller bid price when the second seller bid price is less than the maximum group price and is less than the first seller bid price.

19. The method of claim 17, further comprising:
receiving, from a second seller, a second seller bid with the second seller bid specifying a second seller price at which the second seller is willing to sell the first product and a second seller minimum number specifying a minimum number of the first product that the members of the first group must agree to be purchase before the second seller would to be obligated to sell the first product to the members of the first group at the second seller bid price should the second seller be selected as the seller to sell the first product to the one or more members of the group;
identifying that the second seller bid price is a lower bid price than the first seller bid price; and
identifying that the number of the first product requesting to be purchased by the first group is less than the second seller minimum number; and
setting the second seller bid as a reserve bid in response to the identifying that the number of the first product requesting to be purchased by the first group is less than the second seller minimum number and determining not to set the second seller bid price as the group price in response.

20. The method of claim 19, further comprising:
providing, through the cooperative network of computational servers, group build interface information accessible over the distributed network by thousands of potential buyers, wherein the group build interface information is configured to allow buyers to join the first group and agree to purchase the first product at the first group price when the first seller bid price is set at the group price, and the group build interface information is further configured to cause a reduced price notification to be displayed specifying that the first product is available to members of the first group at the second seller bid price should the number of the first product requested to be purchased by the members of the first group increase to equal or exceed the second seller minimum number.

21. A system configured to establish a competitive supplier market, comprising:
a group generation service configured to establish and maintain multiple different product groups wherein each product group corresponds to a different product requesting to be purchased by members of each respective product group, wherein the group management module comprises:
group build interface circuitry configured to maintain buyer interface information and allow access to the buyer interface information over a distributed network by hundreds of thousands of potential buyers, and further configured to receive information from requesting buyers regarding products requesting to be purchased;
group build circuitry communicationally coupled with the group build interface circuitry, wherein the group build circuitry is configured to receive, through the group build interface circuitry, a request from a first buyer identifying a first product that the first buyer desires to purchase, wherein the first product is not available for purchase through the group generation service at the time the request from the first buyer is received, and the group build circuitry is further configured to establish a first product group exclusively associated with the first product in response to the request from the first buyer, wherein the group build circuitry comprises:
information collection circuitry configured to obtain researched product information including a cost to purchase the first product from one or more other potential product suppliers that are not associated with the group generation service with respect to the first product; and
pricing circuitry configured to determine a maximum group price for the first product based at least in part on the researched product information, wherein the maximum group price is less than a cost to purchase the first produce from one or more of the other potential product suppliers;
wherein the group build circuitry is further configured to direct the group build interface circuitry to allow access, by the hundreds of thousands of potential buyers over the distributed network, to group build interface information that allows potential buyers to communicate requests to join the first product group, and to join to the first product group one or more buyers requesting to join the first product group and agreeing, along with each member of the first product group, to purchase at least one first product at a group price equal to or less than the maximum group price.
